(19) United States
(12) Patent Application Publication
(10) Pub. No.: US 2013/0266924 A1
(43) Pub. Date: Oct. 10, 2013

(54) MULTIMEDIA BASED EDUCATIONAL SYSTEM AND A METHOD

(71) Applicant: Michael Gregory Zelin, Fayetteville, AR (US)

(72) Inventor: Michael Gregory Zelin, Fayetteville, AR (US)

(73) Assignee: Michael Gregory Zelin, Fayetteville, AR (US)

(21) Appl. No.: 13/442,778

(22) Filed: Apr. 9, 2012

(51) Int. Cl. G09B 7/00

(52) U.S. Cl. 434/362

(57) ABSTRACT

A method for providing education and creative activities to at least one user in at least one project based and service learning gaming environment includes the steps of creating at least one multimedia composition by the at least one user, accessing the at least one multimedia composition by the at least one user, retrieving at least one of an advertisement and a sponsor data from at least one database of a plurality of databases and executing a set of instructions to combine the at least one multimedia composition and the at least one of the advertisement and the sponsor data from the at least one database.

### BACKGROUND OF THE INVENTION

1. Field of the Invention

Embodiments of the present invention generally relate to education systems, and more particularly, to, systems and methods for multimedia based educational systems.

2. Discussion of the Related Art

Inability of conventional educational methods to inspire and motivate individuals, evident from high dropout rates and low test scores, resulted in development of a number of novel solutions targeting enhanced student involvement in learning, particularly, educational systems involving electronic games. However, the main disadvantages of said existing educational gaming systems available in the art include limited scope in terms of specific topics, age level, educational level, and the like and a significant expense associated with development of new modules. Moreover, the most technologically advanced systems utilizing virtual world environment focus primarily on teaching aspect of education providing novel tools for developing and delivering teaching content, while learning aspect is still limited by the standard didactic approaches available in the art.

Currently, a wide variety of educational products ranging from CD-ROMS, electronic flash cards, games, to the more expensive computer based training programs and the internet based Learning Management Systems (LMS) have been developed to enhance learning. However, none of them have the combination of educational rigor, inexpensive internet delivery, simplicity of user interface combined with benefits of project based and service learning, that have been proven to enhance learning and provide additional benefits to both learners and to the community.

Existing systems using elements of project based learning and service learning are primarily focused on large scale projects, while regular homework assignment and learning projects remain underutilized. Besides, existing systems using project based and service learning systems typically engage school and college students, while younger students, home school students, and adult students are left out and do not receive benefits of project based service learning.

There remains a need in the art for a system and method for providing didactic principles of project based learning and service learning engaging learners in creative activities, and hands-on learning that significantly improve learning outcomes. The present invention provides such a system and a method of project based service learning eliminating disadvantages of the prior art, rewarding learning, creativity, and positive behaviors, that can also be used for creative and recreational activities and for providing multiple services and online database resources.

### BRIEF DESCRIPTION OF THE FIGURES

So that the features of the present invention can be understood in detail, a more particular description of the invention with a reference to embodiments, some of which are illustrated in the appended drawings, is provided. It is to be noted, however, that the appended drawings illustrate only typical embodiments of this invention and are therefore not to be considered limiting of its scope, for the invention admit to other equally effective embodiments.

The features, benefits and advantages of the present invention will become apparent by reference to the following text figures, with like reference numbers referring to like structures across the views, wherein:

FIG. 1 illustrates a system for providing education to at least one user in a project based and service learning gaming environment, according to one embodiment of the present invention;

FIG. 2 illustrates shows a schematic diagram illustrating a multi-level relationship between organizational users, according to one embodiment of the present invention;

FIG. 3A illustrates a schematic diagram illustrating a design of multiple databases and multiple links to multiple online databases of arts materials, according to one embodiment of the present invention;

FIG. 3B illustrates a schematic diagram illustrating a design of multiple databases and multiple links to multiple online databases of scientific materials, according to one embodiment of the present invention;

FIG. 3C illustrates a schematic diagram illustrating a design of multiple databases and multiple links to multiple online databases of materials related to history of multiple individual users, according to one embodiment of the present invention;

FIG. 4A illustrates a schematic diagram illustrating a design of template of a time line of a plurality of individual users, according to one embodiment of the present invention;

FIG. 4B illustrates a schematic diagram illustrating a design of template of a time line of a plurality of organizational users, according to one embodiment of the present invention;

FIG. 4C illustrates a schematic diagram illustrating a design of template of a daily timeline, according to one embodiment of the present invention;

FIG. 5A illustrates a schematic diagram illustrating materials related to one or more stages of development of a creative product, according to one embodiment of the present invention;

FIG. 5B illustrates a schematic diagram illustrating materials related to one or more stages of development of a scientific product, according to one embodiment of the present invention;

FIG. 6 illustrates a screenshot of a composition combining a children poem written with food colors and an image, according to one embodiment of the present invention;

FIG. 7 illustrates a schematic diagram illustrating one or more types of Reality Game, according to one embodiment of the present invention;

FIG. 8A illustrates a screenshot of an RPG Forum game exemplifying a Travel Game, according to one embodiment of the present invention;

FIG. 8B illustrates a screenshot of an RPG Forum game exemplifying a Music Game, according to one embodiment of the present invention;

FIG. 8C illustrates a screenshot of an RPG Forum game exemplifying a Concert Game, according to one embodiment of the present invention;

FIG. 8D illustrates a screenshot of a RPG Forum game exemplifying a Honest Game, according to one embodiment of the present invention;

FIG. 8E illustrates a screenshot of a RPG Forum game exemplifying an Engineering Game, according to one embodiment of the present invention;

FIG. 9 illustrates a screenshot of a page related to a tutorial on innovation and body mechanics aspects of Martial Arts, according to one embodiment of the present invention; and

FIG. 10 illustrates a screenshot of a page of a service learning gallery, according to one embodiment of the present invention.

### BRIEF DESCRIPTION OF THE INVENTION

Embodiment of the present invention provide a system for creative and educational activities including, but not limited to project based learning and service learning to one or more users in a gaming environment, which includes multiple databases of resource materials: text, graphic, audio, and video information, templates, tutorials, and other information and tools enabling users' learning and creative activities and databases of links to said materials, one or more processors configured to execute one or more set of instructions for providing education and creative activities to the one or more users in the gaming environment, and a set of modules coupled to multiple databases.

Another embodiment of the present invention further provides, a system for providing education to at least one user in a project based and service learning gaming environment. The system includes a central processing unit, a set of support circuits and at least one server computer for communicating over a communication network. Particularly, the server includes at least one processor configured to execute at least one set of instructions for providing educational and multiple creative activities to the at least one user in the gaming environment, a memory device coupled to the at least one processor, the memory device includes multiple modules configured to enable the at least one user to create at least one multimedia composition selected from a group including a multimedia composition composed individually, multiple multimedia compositions composed in at least one team, and the like, conduct e-commerce in the gaming environment, and provide an interactive learning environment to the at least one user via the communication network and at least one of multiple databases and multiple links each associated with the multiple databases, having stored therein the at least one set of instructions for execution by the at least one processor for providing education and creative activities to the at least one user in the gaming environment and an interface to provide access to the server from multiple client devices over the communication network. Further, the system is configured for providing an increased efficiency of learning and creative activities and optimized user experience.

Another embodiment of the present invention further provides, a method for providing education to at least one user in at least one project based and service learning gaming environment including the steps of creating at least one multimedia composition by the at least one user, accessing the at least one multimedia composition by the at least one user, retrieving at least one of an advertisement and a sponsor data from at least one database of multiple databases, and executing a set of instructions to combine the at least one multimedia composition and the at least one of the advertisement and the sponsor data from the at least one database.

A further embodiment of the present invention provides, a method for displaying at least one self-multiplying advertisement to at least one user in at least one project based and service learning gaming environment, the method includes the steps of selecting the at least one advertisement from at least one database of multiple databases by the at least one user, and specifying multiple parameters for determining a manner of displaying the at least one advertisement by the at least one user and determining content of multiple user pages for inappropriate words, images, and the like associated with the advertisement.

In one embodiment of the present invention, the system further includes multiple multimedia modules for enabling the one or more users to create and showcase multimedia compositions, managing users and social interaction, including individual and organizational users, conducting commerce and receiving financial benefits, and other modules for customizing said educational gaming system for the optimized users' learning and creative activities.

In one embodiment of the present invention, the multiple databases include a multimedia database and/or links to the Web based corresponding information, a scientific information database and/or links to the Web based corresponding information, a historic information database and/or links to the Web based corresponding information, a player database and/or links to the Web based corresponding information, a non-profit organizations database and/or links to the Web based corresponding information, a for-profit organizations database and/or links to the Web based corresponding information, a mentoring and consulting database and/or links to the Web based corresponding information, a projects database and/or links to the Web based corresponding information, a tutorial database and/or links to the Web based corresponding information, an advertisements database and/or links to the Web based corresponding information, a gaming database and/or links to the Web based corresponding information, a players' societies database and/or links to the Web based corresponding information, a tests database and/or links to the Web based corresponding information, a competitions database and/or links to the Web based corresponding information, a templates database and/or links to the Web based corresponding information, a polls database and/or links to the Web based corresponding information, a mental exercise database and/or links to the Web based corresponding information, a database of materials for expressive therapies and/or links to the Web based corresponding information, and a rewards database and/or links to the Web based corresponding information.

In yet another embodiment of the present invention, the system further includes multiple multimedia modules for creating and showcasing the multiple multimedia compositions. Particularly, the multiple multimedia modules include a content management module and a content processing module enabling text, image, sound, and video processing.

In yet another embodiment of the present invention, the multiple modules further include a user management module, a collaboration management module, a social interaction management module, a control module, an analytics module and a conflict resolution module.

In yet another embodiment of the present invention, the multiple modules further include a commerce module, a reward module, and an advertising module the reward module is configured to provide financial incentives in a form of revenues derived from advertising and sponsor links posted on the at least one user interface, licensing fees, competition prizes, and selling of an original content and non-financial incentives, the original content and non-financial incentives comprise diploma certificates, and the like and reflecting service hours and community service points evaluated according to at least one algorithm by the reward module.

In yet another embodiment of the present invention, the system further comprises a gaming module, an artificial intelligence simulation module, a customization module, and an optimization module.

In yet another embodiment of the present invention, the multiple modules are configured to facilitate multiple services, wherein the multiple services comprise multiple training services, multiple enhancing project based and service based learning services, multiple matching services for the at least one user, multiple matching services for multiple organizational users, multiple services for family and friends searching and strengthening of ties, multiple organizational loyalty services, multiple customer loyalty services, multiple recruitment and retention services, multiple identification and promotion of best practices honoring best businesses or individuals services, multiple identification and exposure of unacceptable practices, businesses, and individuals services, multiple market research and business evaluation services, multiple secret shopper services evaluating enterprise efficacy, openness to new external ideas, responsiveness to external communication, and the like, multiple real and virtual travel and food services, multiple tutoring services, multiple physical and psychological training services, multiple testing and test anxiety control services, multiple lost & found services, multiple inventor services, multiple investor services, multiple talent search services, multiple intellectual property protection services, multiple artistic creations evaluation and improvement services, multiple web design services, multiple commerce services and the like.

### DETAILED DESCRIPTION OF THE EMBODIMENTS

Embodiments of the present invention relate to a system and method for providing education to at least one user in a project based and service learning gaming environment. Moreover, the present system is configured for project based and service based learning via showcasing users' learning projects, presentations, and any other types of learning assignments or creative activities and adding to the user pages links of non-profit organizations and/or links of sponsors providing support to the non-profit organizations and rewarding the service learning and creative activities.

Various methods and systems disclosed by the present invention assume a variety of physical and logical configurations, including a variety of computers employing a number of different operating systems and network configurations. In one embodiment, a system for providing education to at least one user in a project based and service learning gaming environment includes a server and at least one user interface. In use, the user interface is a computer, and the educational gaming system for providing education to the at least one user in the project based and service learning gaming environment includes multiple computers.

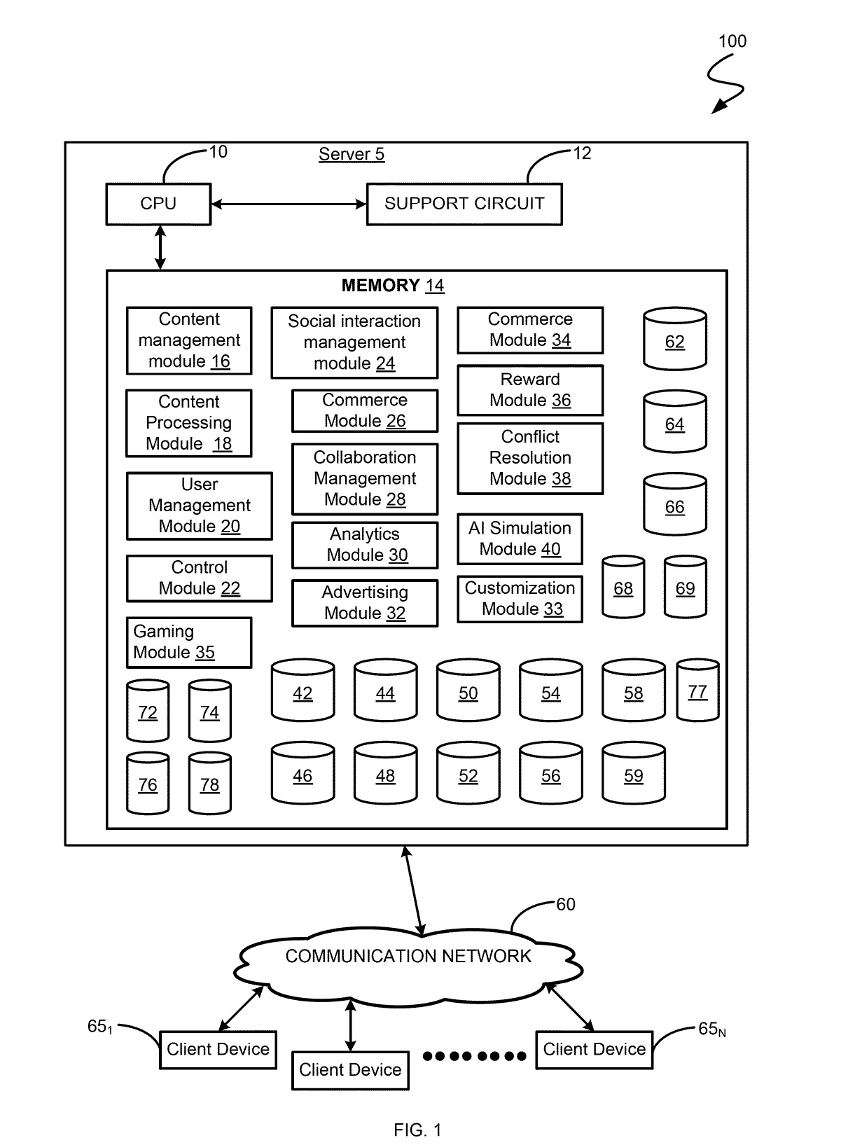

In accordance with an embodiment of the present invention, FIG. 1 illustrates a system 100 for providing education to the at least one user in the project based and service learning gaming computer-based environment. The server 5 of the project based and service learning system 100 includes a processor coupled to a data storage device. Each client device 65 of the multiple computers of the project based and service learning system 100 includes a client program, or software means, which is operatively or communicatively coupled to the server 5. The system 100 for project based and service learning gaming environment for multiple users includes a central processing unit 10, a set of support circuits 12 and at least one server computer 5 for communicating over a communication network 60. The server 5 includes at least one processor configured to execute at least one set of instructions for the project based and service learning gaming environment, a memory device coupled to the at least one processor. Particularly, the memory device includes multiple modules configured to provide an interactive learning environment to the multiple users via the communication network 60 and multiple databases, having stored therein the at least one set of instructions for execution by the at least one processor and an interface to provide access to the server 5 from the multiple client devices 65₁, . . . , 65_{N} over the communication network 60.

In one embodiment of the present invention, the multiple modules include a content management module 16, a content processing module 18 enabling text, image, sound, and video processing, a user management module 20, a social interaction management module 24, a collaboration management module 28, a control module 22, an analytics module 30, an advertising module 32, a commerce module 34, and a conflict resolution module 38.

In yet another embodiment of the present invention, the multiple modules further include a commerce module 26, and a reward module 36. Particularly, the reward module 36 is configured to provide financial incentives in a form of revenues derived from advertising and sponsor links posted on the at least one user interface, licensing fees, competition prizes, and selling of an original content and non-financial incentives. Moreover, the reward module 36 is configured to evaluate service hours and community service points according to one or more algorithms. Further, the multiple modules are configured to facilitate multiple services.

Particularly, the multiple services include multiple training services, multiple enhancing project based and service based learning services, multiple matching services for the one or more users, multiple matching services for multiple organizational users, multiple services for family and friends searching and strengthening of ties, multiple organizational loyalty services, multiple customer loyalty services, multiple recruitment and retention services, multiple identification and promotion of best practices honoring best businesses or individuals services, multiple identification and exposure of unacceptable practices, businesses, and individuals services, multiple market research and business evaluation services, multiple secret shopper services evaluating enterprise efficacy, openness to new external ideas, responsiveness to external communication, and the like, multiple real and virtual travel and food services, multiple tutoring services, multiple physical and psychological training services, multiple testing and test anxiety control services, multiple lost & found services, multiple inventor services, multiple investor services, multiple talent search services, multiple intellectual property protection services, multiple artistic creations evaluation and improvement services, multiple web design services, multiple commerce services and the like.

In one embodiment of the present invention, the original content and non-financial incentives include diploma certificates, and the like. In yet another embodiment of the present invention, the multiple modules further include a gaming module 35, an artificial intelligence simulation module 40, a customization module 33, and an optimization module 39.

In accordance with an embodiment of the present invention, the system 100 includes the multiple multimedia modules for enabling the one or more users to create and showcase multimedia compositions. Moreover, the system 100 is configured for managing the multiple relationships between the one or more users including individual and organizational entities and the multiple links corresponding to each database of the multiple databases are provided to the one or more users.

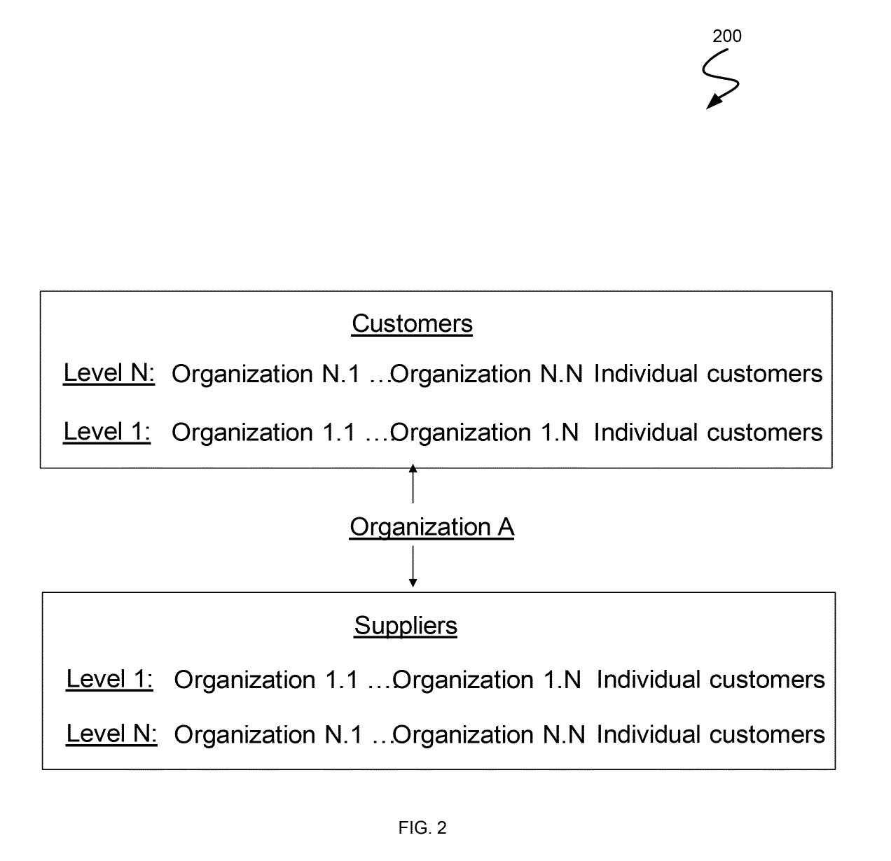

FIG. 2 shows a schematic diagram illustrating a multi-level relationship 200 between organizational users, according to one embodiment of the present invention. Particularly, the interaction is done through use of a timeline, which include multiple organizational users and the timeline enables the one or more companies to establish vertical and horizontal relationships with customers, suppliers, and industry partners, during co-branding advertisements, joint charity projects, and the like via the multiple modules of the present invention. Moreover, the timeline generated in the present invention further include one or more types of organizations not only manufacturers for establishing relationships between suppliers and customers of one or more levels, thereby allowing the users to optimize the system 100 using neural network mechanisms.

In accordance with an embodiment of the present invention, the system 100 further includes a multimedia database 42, a scientific information database 44, a historic information database 46, a player database 48, a non-profit organizations database 50, a for-profit organizations database 52, a mentoring and consulting database 54, a projects database 56, a tutorial database 58, an advertisements database 59, a gaming database 62, a players' societies database 64, a tests database 66, a competitions database 68, a templates database 69, a polls database 72, a mental exercise database 74, a expressive therapies material database 76, a creative therapy database 77 and a rewards database 78.

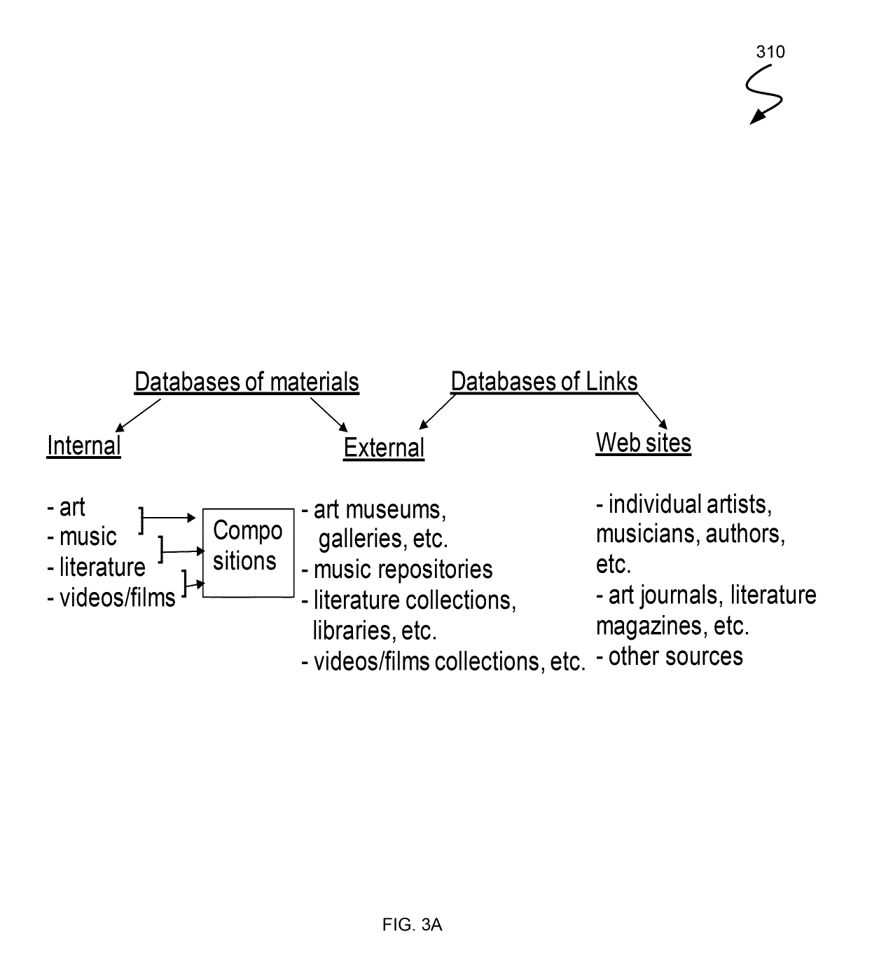

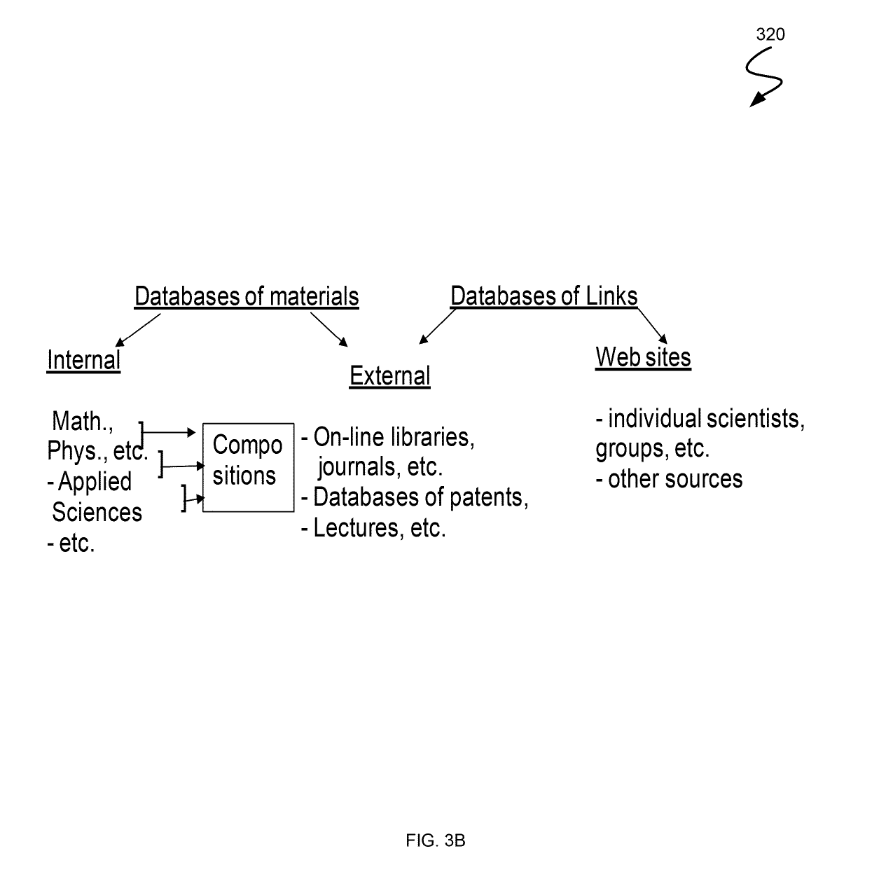

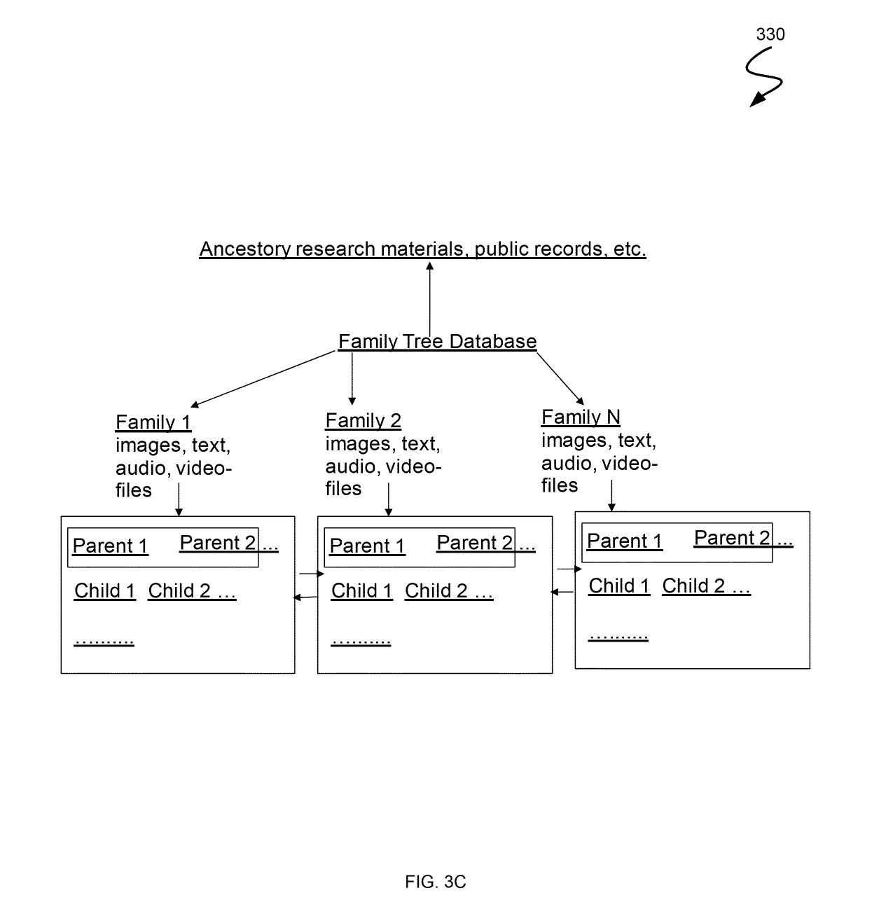

FIG. 3A illustrates a schematic diagram 310 illustrating a design of multiple databases and multiple links to multiple online databases of arts materials, according to one embodiment of the present invention. Particularly, the multimedia databases are configured for storing pieces of literature, art, music, and films, one or more links to the pieces of information in one or more formats, and multiple multimedia compositions are produced by combining the pieces of information by the one or more users. FIG. 3B illustrates a schematic diagram 320 illustrating a design of multiple databases and multiple links to multiple online databases of scientific materials, according to one embodiment of the present invention. Particularly, the scientific information database 44 is configured for storing scientific information or multiple links to the web based information in one or more formats, including text, image, audio, video, and the like as illustrated in FIG. 3B of the present invention. FIG. 3C illustrates a schematic diagram 330 illustrating a design of multiple databases and multiple links to multiple online databases of materials related to history of multiple individual users, according to one embodiment of the present invention. The historic information database 46 is configured for storing historic information or links to the web based information related to history of individuals, organizations, cities, countries, and the like.

In accordance with an embodiment of the present invention, the player database 48 is configured for storing multiple user names, including organizational users, names of user created characters for RPG and RPG Forum games, and names (titles) of user created multimedia compositions or links to the Web based information. In use, the player database 48 include names of organizations, teams, companies, and fictitious characters from literature, art, music, cinematography, and titles of literature, art, music, films, and the like or links to said Web based information. The non-profit organizations database 50 is configured for storing information or links to the Web based information related to educational, health related, religious, government, and any other type of non-profit organizations accepting monetary, non-monetary, and any other type of donations. The for-profit organizations database 52 is configured for storing information or links to the Web based information related to for-profit organizations, non-profit, government, and any other type of organizations providing monetary, non-monetary, and any other type of donations and support to non-profit organizations and individuals.

In accordance with an embodiment of the present invention, the mentoring and consulting database 54 is configured for storing information or links to the Web based information related to multiple experts in various fields capable of providing mentoring, consulting, or any other type of support to the one or more user. In use, the mentoring and consulting database 54 includes galleries of work, rating index, citation index, commerce capabilities, licensing capabilities, and other similar characteristics of various mentors and consultants. The projects database 56 is configured for storing information or links to the Web based information related to multiple projects, including design, market research, and other type of educational, as well as non-educational projects facilitating development of design, innovative thinking, and other useful skills and socially responsible attitudes. The tutorial database 58 is configured for storing information or links to the Web based information related to one or more fields, including, but not limited to tutorials on various disciplines, arts, sports, innovation, safety, and other areas of corporate, school, and individual learning and activities. The advertisements database 59 is configured for storing information or links to the Web based information related to text, image, video, and any other types of advertisements. The gaming database 62 is configured for storing educational and non-educational games or links to the Web based games including online games, video games, sport games, and any other type of physical and non-physical games. In use, the gaming database 62 includes everyday life games including Honest Game, Love Game, and the like, creative games including innovation games. Moreover, the innovation games include Invention Game and Patent Game, art games include Art, Music, Literature, Cinema Games, business games include Funding Game, Proposal Game, Promotion Game, and the like, electronic games include Computer Games (games with a computer), Phone Games (games with a telephone), and the like, competition games include competitions of mathematics projects, physics projects, chemistry projects, and the like and physical game competitions includes football, basketball, soccer, hockey, and the like. It is to be appreciated that the game owners post ads/sponsor links from the corresponding databases and receive a portion of membership fees. The one or more players create one or more multimedia compositions based on these games incorporating screenshots, videos, music, or text related to the games, including educational games, and an universal score is further evaluated by combining user's rating in one or more games by using weighted coefficients.

In accordance with an embodiment of the present invention, the player societies' database 64 is configured for storing information or links to the Web based information related to gaming societies, interest groups, and other types of associations of users according to their interests. The tests database 66 is configured for storing information or links to the Web based information related to tests including tests in various disciplines, physical and psychological tests, and any other type of tests designed for individuals and organizations. The competitions database 68 is configured for storing information or links to the Web based information related to online and any other types of competitions.

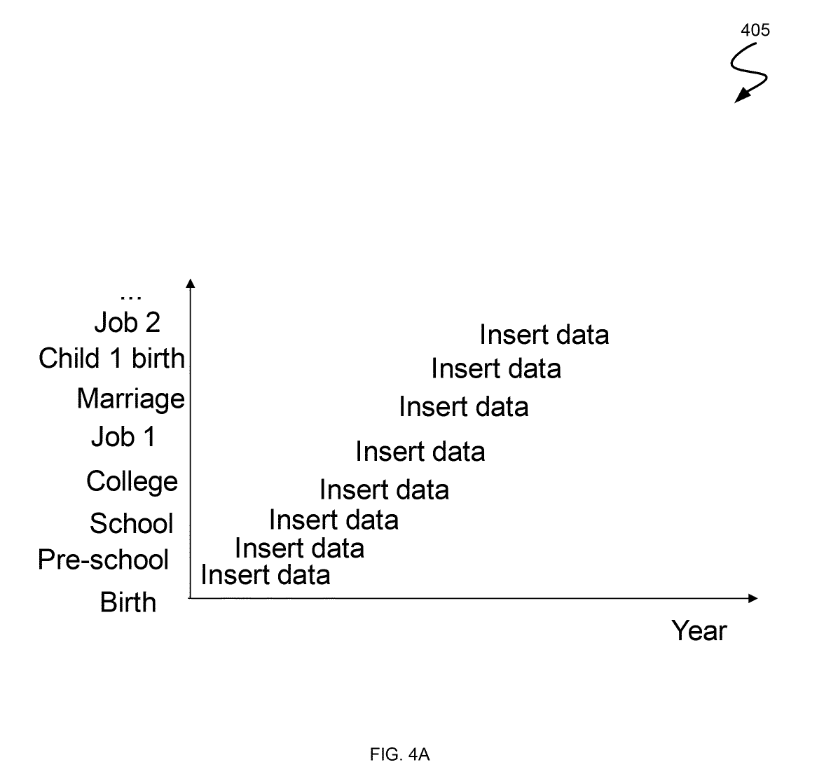

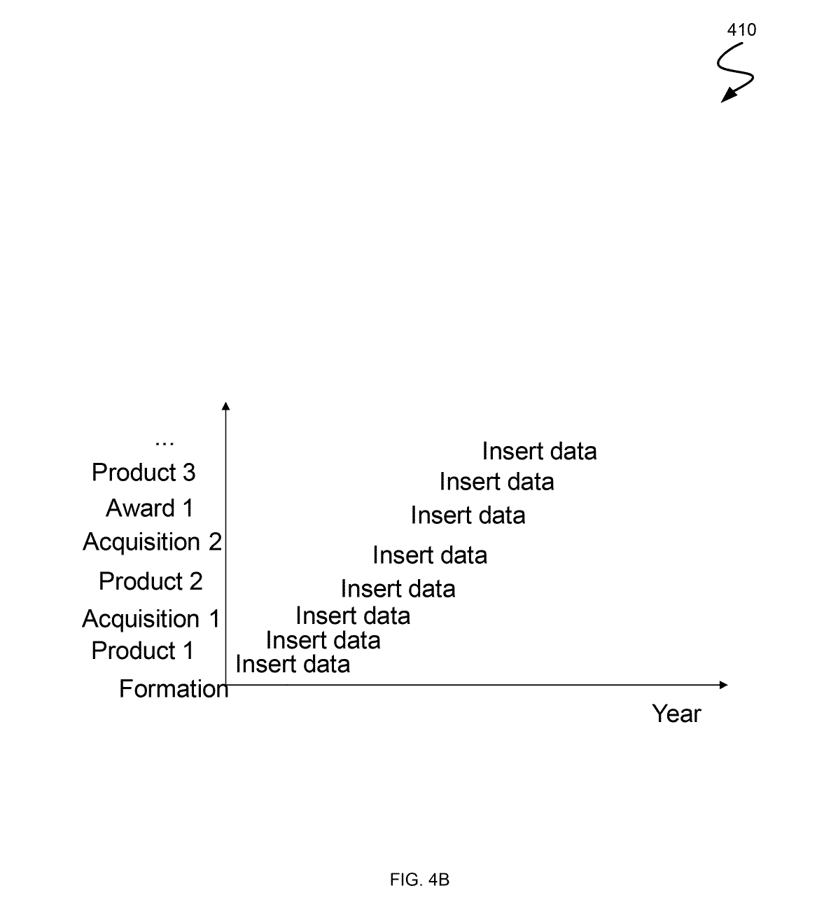

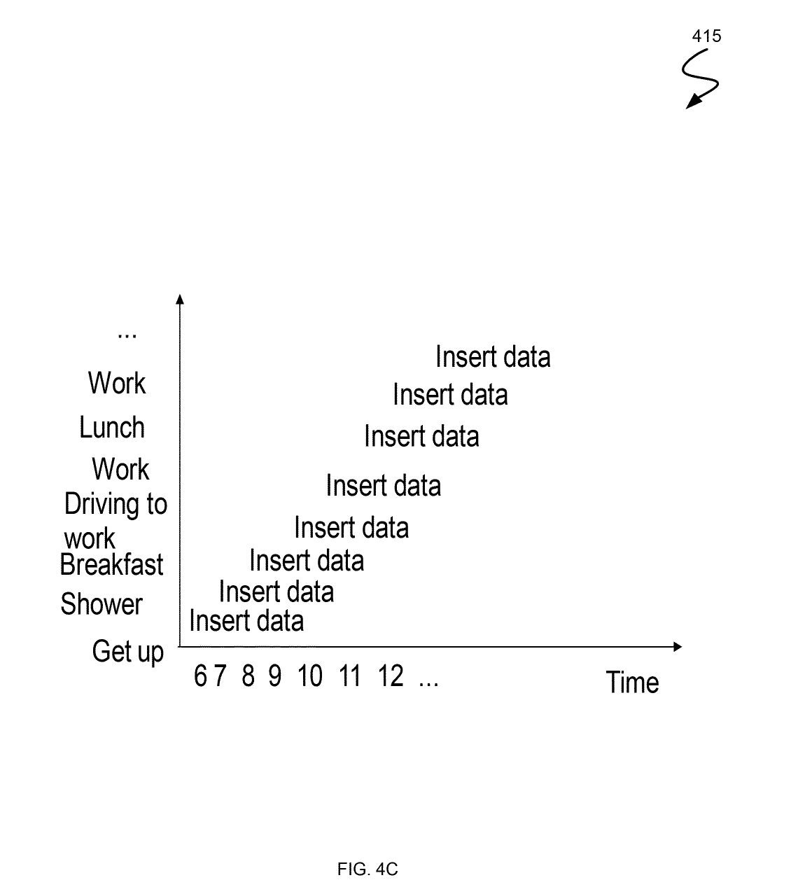

FIG. 4A illustrates a schematic diagram illustrating a design of a template of a time line 405 of multiple individual users, FIG. 4B illustrates a schematic diagram illustrating design of a template of a time line 410 of multiple organizational users, and FIG. 4C illustrates a schematic diagram of a daily timeline template for individual users related to daily activities, including, but not limited to morning shower, coffee, breakfast, driving to work, and the like according to one embodiment of the present invention. The templates database 69 of the present invention is configured for storing multiple templates of the multimedia compositions, documents, including, but not limited to legal documents, financial documents, honor diploma, thank you cards, e-cards, individual and organization timelines, web sites, web design components, and the like or links to the Web based information. The multiple templates further include at least one of e-cards/videos for holidays, life events birthday, marriage, anniversary, graduation, etc. honor certificates, thank you cards, and the like. Furthermore, the one or more users have flexibility in customizing the multiple templates, whereby the users add images, music, text, and combine templates on split screens (display simultaneously several templates), tools for editing images, video, sound, text, user gallery displaying creations, and the like. Additionally, synergy with family tree and friend tree (social) modules for individual and group (team, corporate, etc.) users be delivered to the end user through various means, including, internet, cell phone, across various platforms, such as, for example, tweets, SMS, text messages, and the like. The polls database 72 is configured for storing information or links to the Web based information related to multiple polls and any other type of user provided feedback information.

In accordance with an embodiment of the present invention, the mental exercise database 74 is configured for storing information or links to the Web based information related to multiple puzzles, including multimedia puzzle, crossword, and other intellectual activities information. The multimedia puzzle information or links to the Web based information includes databases of pieces of literature, art, music, and films, which be broken into parts (pieces of multimedia puzzle) or indexed to find a required element.

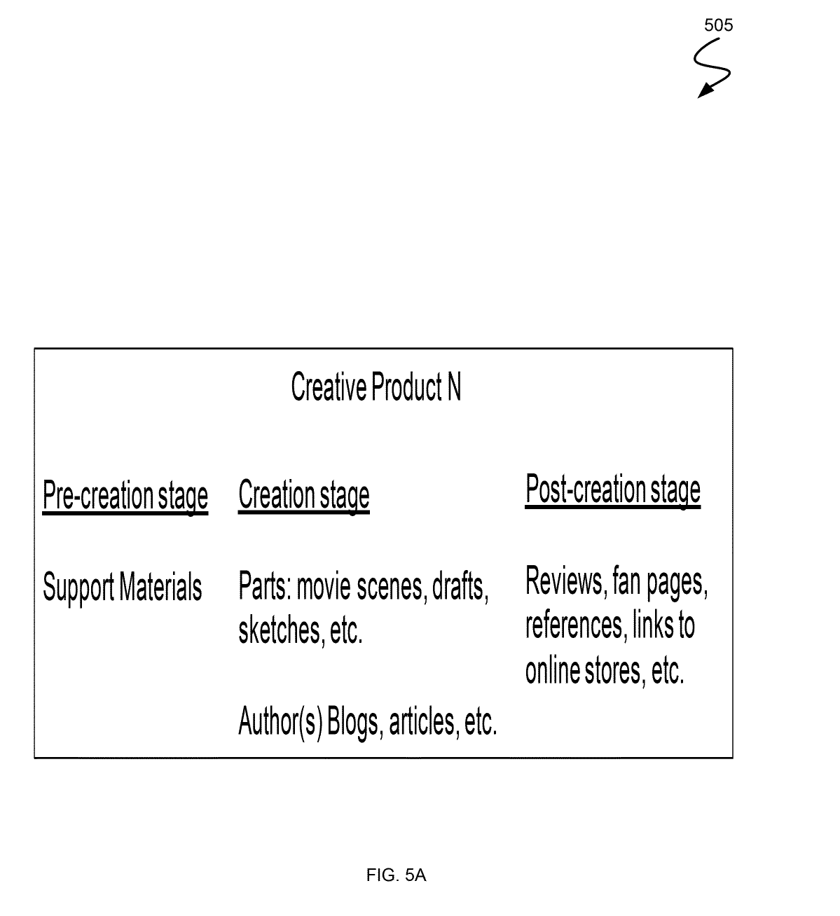

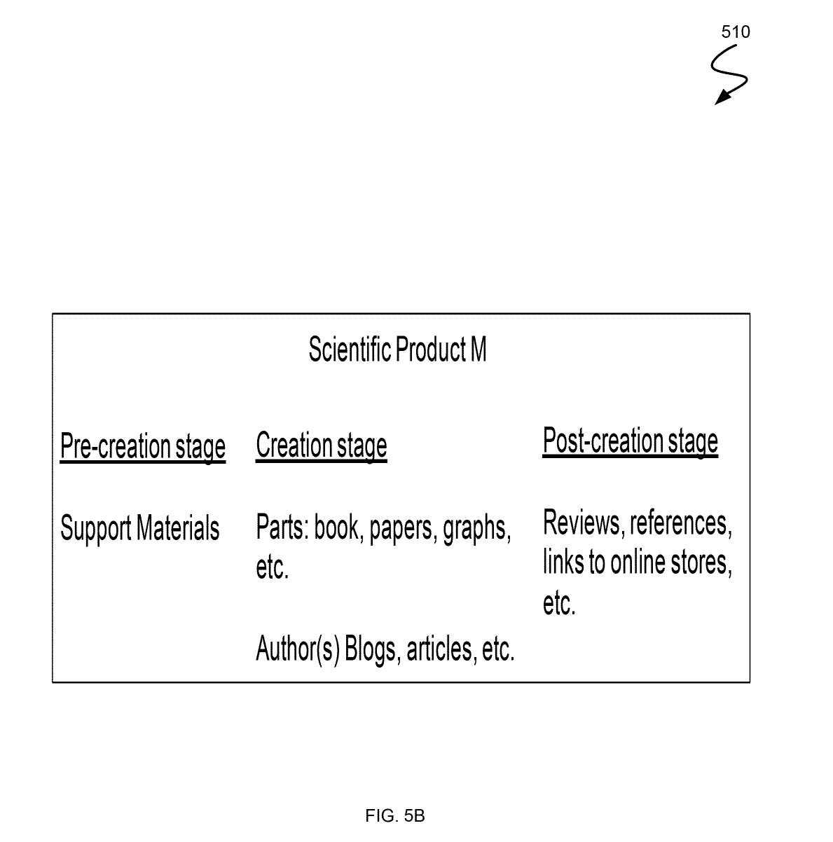

FIG. 5A illustrates a schematic diagram 505 illustrating materials related to one or more stages of development of a creative product, and FIG. 5B illustrates a schematic diagram 510 illustrating materials related to one or more stages of development of a scientific product, according to one embodiment of the present invention. The mental exercise database 74 includes materials from one or more stages of development of the creative product as illustrated in FIG. 5A of the present invention and the scientific product as illustrated in FIG. 5B of the present invention, and any other product which includes pre-creation, creation, and post-creation stages. The one or more users combine existing pieces and add new pieces and get rewarded through ad/sponsor links, competition prizes, citation index, relational links established based on viewers' rating, and the like. The expressive therapy database 77 is configured for storing information or links to the Web based information related to resources for the art, music, poetry, and other types of expressive therapy and mindful training. The rewards database 78 is configured for storing information or links to the Web based information related to rewards, including monetary, non-monetary, and any other types of rewards.

In accordance with an embodiment of the present invention, the system 100 further includes multiple multimedia modules for creating and showcasing the plurality of multimedia compositions, and the plurality of multimedia modules includes the content management module 16 configured for retrieving at least one data from the multiple databases, to create multiple multimedia compositions by the at least one user, displaying user created compositions in public or private password protected galleries and sub-galleries hierarchically arranged for multiple topics within at least one gallery related to a same field or subject and the like, and the content processing module 18 enabling text, image, sound, and video processing. For example, the present invention provides a text box with extended capabilities for processing textual information. Said capabilities include ability to arrange text in layers and change visible portions of the text between said layers, embed audio and image files, including, but not limited to advertisement and sponsor links, change the shape of the text, and provides rating functionality enabling users to rate various portions of the text and show the rate upon a specified mouse over event or any other specified action. Furthermore, said text box with extended capabilities enables users to keep track of all changes and actions, including, but not limited to copying and pasting multiple text boxes and their hierarchical relationships. Furthermore, said text box with extended capabilities enables users to incorporate elements of word games, including, but not limited to charade games, games based on search for hidden words or missing letters, and games based on using homophones, fuzzy word search, and writing accents. Furthermore, said text box with extended capabilities extends text analytics functionality beyond character and word counting to calculating according to a specified algorithm information entropy, humor index, citation index (number of links to said text box or a document containing said text box with extended capabilities), and reference index (number of links to the original text related to the text in said text box or in a document containing said text box with extended capabilities). As a part of the modules, the present invention provides plugins that enable the users to embed one or more modules for creating multimedia compositions and text, image, sound, and video processing on their Web sites for a fee or free of charge depending on the configuration allowing selection of desired one or more modules.

In accordance with an embodiment of the present invention, the system 100 further includes the user management module 20 configured for enabling user authentication, and executing a set of instructions to create a plurality of user accounts, tracking a user progress of the multiple users from at least one common organization according to multiple parameters.

In accordance with an embodiment of the present invention, the multiple parameters include a class, a grade, an organization department, multiple users' names, rating of the multiple multimedia compositions, grading by multiple teachers, a plurality of links to the plurality of multimedia compositions, a plurality of comments, and the like. The collaboration management module 28 is configured to manage collaboration between multiple users on at least one of an individual level and a team level, and conduct a plurality of online competitions for selecting a best multimedia composition, create rubrics and specify a plurality of judging criteria, invite a plurality of judges and enter a score, and the like. The social interaction management module 24 is configured to contact the multiple users determined as friends, execute a set of instruction to share the at least one multimedia composition information in a real time and create at least one new multimedia composition by the friends, contact the multiple users based on at least one share parameter to rate at least one of the multiple user's original multimedia compositions, and multiple users modified multimedia compositions proposed by the multiple users in real time. Particularly, a contact sub-module (not shown) retrieves information about the plurality of users determined as the at least one friend from at least one user database and the at least one share parameter includes the multiple users sharing at least one topic of interest and the like. The control module 22 is configured to retrieve at least one multimedia composition with an inappropriate content stored in the at least one database by the at least one user and control multiple multimedia compositions constituting plagiarism, by executing a set of instructions to remove and/or modify the at least one multimedia composition stored in the one or more databases. The inappropriate content includes a derogatory language, a hatred language and any other inappropriate language and the like. The conflict resolution module 38 is configured to store multiple forms or information of the multiple forms to the one or more databases of the present invention, generate at least one conflict resolution solution, and the like. Moreover, as a part of the modules, the present invention provides plugins that enable users to embed user management, user collaboration, conflict resolution, and user control modules on their Web sites for a fee or free of charge depending on the configuration allowing selection of desired one or more modules and user status.

In accordance with an embodiment of the present invention, the system 100 further includes the commerce module, a reward module configured to evaluate corresponding reward made to said plurality of users, deliver said rewards in monetary and non-monetary form, including, but not limited to discount coupons, products, and the like; and an advertising module configured to enable said plurality of users to create a plurality of advertisements and a plurality of sponsor banners, add said plurality of user created and/or existing advertisement links and/or said plurality of sponsor links to users' pages, and the like. Financial incentives including revenues derived from advertising and sponsor links posted on users' pages are directly linked to users' rating, number of views of a composition hosting said advertising and sponsor links, and the like. Users have a choice of advertisements and sponsor links, that they can post on their pages. Users can receive scholarships, bonds, or any other type of rewards from advertisers and sponsors, whose links are posted on said user pages or selected in said user database of advertisers and sponsors if said user spent a specified amount to buy said advertisers' and sponsors' products. Further, the present invention provides another reward mechanism based on licensing fees. Authors of the original content receive a specified percent of the revenues derived by a user utilizing said original materials. Further, the present invention provides another mechanism rewarding creativity, learning, and community service enabling users to sell their original content in online stores. For example, a user can create study guides, laboratory activities, books helping to learn various subjects or skills, and other creative and educational products and post them for sale in an existing online store or in a store built by using tools provided by the present invention. Further, the present invention provides another reward mechanism based on use of lotteries and sweepstakes. As a reward for achieving a certain level, producing a composition with a certain rating and/or number of views, acquiring a paid membership, or any other specified action, a user can receive a lottery ticket or enter in a sweepstake. Further, the present invention provides another reward mechanism based on non-financial incentives including, but not limited to honor diploma, certificates, and the like reflecting service hours and community service points calculated according to a special algorithm. Said algorithm for service hours and community service points considers time spent by a user on a project, project rating, number of views, and other parameters reflecting efficacy of said user project in supporting non-profit organizations. As a part of the modules, present invention provides plugins that enable users to embed online commerce and reward module on their Web sites for a fee or free of charge depending on the configuration allowing selection of desired one or more modules.

In accordance with an embodiment of the present invention, the system further includes a gaming module configured to provide at least one of a plurality of entertaining games and a plurality of links to said plurality of entertaining games, a plurality of links to a plurality of physical games retrieved from a physical game database, for generating virtual characters, including but not limited to executing a set of instructions to provide means to retrieve at least one RPG character from said avatar database, weapons, tools, and other gaming items, character traits, power, and the like; an artificial intelligence simulation module configured to analyze at least one user's behavior based on a plurality of user's input means, to mimic human behavior in playing against at least one computer means, and the like, a customization module configured to provide means for authors to customize authoring tool and environment including, but not limited to background, layout, text font, and other elements according to said user preferences, to select and customize set of resource databases, to provide means for viewers to customize viewing environment, and the like and an optimization module configured to optimizes user's learning and gaming experience, including engaging a plurality of senior users in a plurality of cognitive exercise, learning ancestry, engaging a plurality of young users in learning at least one of fields comprising reading, arts, music, and the like. As a part of the modules, the present invention enables users to embed a plugin for online gaming, customization, and simulation modules on their Web sites for a fee or free of charge depending on the configuration allowing selection of desired one or more modules.

In accordance with an embodiment of the present invention, the multiple modules are configured to provide the plurality of services including multiple training services, which include training in innovation, safety, languages, and the like, multiple matching services for multiple individual users, which include matching users with specific interests, psychological profile, or any other criteria, multiple matching services for multiple organizational users, which include matching corporations, government, and any other types of organizations with potential business partners, multiple family and friends searching and strengthening of ties, which include family tree and friends tree development and building and cross-linking individual timelines, multiple organizational loyalty services strengthening ties between corporate business partners, government, educational, and any other type of organizations, multiple customer loyalty services strengthening ties between corporate, government, educational, and any other types of organizations and their customers and individuals, multiple secrete shopper services evaluating enterprise efficacy, openness to new external ideas, responsiveness to external communication, and the like, multiple recruitment and retention services increasing recruitment and reducing student dropout rate at educational organizations and turnover rate at companies, government, and other types of organizations, multiple identification and promotion of best practices honoring best businesses or individuals services, which include, posting information about the businesses and individuals on the digital Wall of Honor, Gallery of Fair Players, or any other type of digital gallery, multiple identification and exposure of unacceptable practices, businesses, and individuals services, which include, but not limited to posting information about the businesses and individuals on the digital Wall of Shame, Gallery of Unfair Players, or any other type of digital gallery, multiple market research and business evaluation services; multiple real and virtual travel and food services, multiple tutoring services, multiple physical and psychological training, multiple testing and test anxiety control services, multiple lost & found services; multiple inventor services, which include, but not limited to invention idea evaluation, prototype development, marketing, including, social networking, and other services, multiple investor services, which include, but not limited to stock market research, new business opportunities evaluation and consulting, and other services increasing shareholders' value and enterprise efficiency, multiple talent search services, which include, but not limited to online competitions for the best poetry, art, music, video, scientific paper or any other type of arts or science related original creation; multiple intellectual property protection services, which include, but not limited to search for unauthorized use of the original content, patent and copyright violation, and the like; multiple artistic creations evaluation and improvement services, which include, but not limited to collecting user feedback and suggested improvements to arts, literature, music, and other types of arts, including new creations and old creations, multiple web design services, which include, but not limited to, design of individual and organizational e-portfolios, timelines, trading cards, flash cards, strategy gaming cards, and any other type of Web-based information, and multiple commerce services, which include, but not limited to enabling financial transactions, offering users' content for sell and licensing, with said modules including plugins that can be installed on user sites to provide said services.

High flexibility of the present invention enables providing training services in various fields, including, but not limited to training in innovation, safety, languages, and the like. The present invention provides resource database and tools for creating online multimedia compositions on one or more subjects enabling trainees' hands-on learning. For example, the present invention provides examples of homework assignment problems with solutions. Learners can create their own problems by modifying the original problems and provide solutions for their versions of the problems. When implemented in class or online learning, this enables instructors to engage learners in an active processing of the learned material enhancing learning outcomes and to develop an extended database of learning materials. Combined with tutorials database, the present invention also provides learning materials and tools for development said learning materials including, but not limited to lecture notes, lesson plans, assignments, and the like. Moreover, by combining the user management module and commerce module, the present invention provides a complete learning management system (LMS) for providing highly efficient training services. Subsequently, the present system can be readily incorporated within existing training service systems or can be used to develop a new training service. The new incentives and rewards provided by the present invention enhance trainees' engagement in learning thereby improving learning outcomes. The present invention provides plugins that can be installed on users' sites to provide said service.

Furthermore, the present invention enables efficient online competition conducting services. The individual or organizational users can initiate, manage, and conduct competitions on various subjects and topics, including, but not limited to science, art, engineering, sports, and any other field. The present invention enables rating of user created compositions online, inviting judges, developing rubrics, finding partners, donors, and sponsors, providing prizes, delivering said prizes, and management of the other aspects of online competitions. The flexibility of the present invention enables users to customize user created competitions in order to engage other users in learning and creative activities. The present invention provides multiple templates for conducting online math, physics, chemistry, biology, and other types of science competitions, graphical art, music, and other types of art competitions, football, soccer, and any other sport competition, and other types of competitions involving users of different age, ethnic, social, and professional background. The present invention also provides multiple resources for conducting and examples of online competitions in various fields and related to different aspects of users' life, including, but not limited to study, work, personal life, hobbies, and the like. Specific examples include, but are not limited to: Creative Neighbor Challenge, a competition involving residents of one or multiple allotments in creative activities related to their personal and social life, Creative Fighting of Dementia, a competition involving senior users (sixty five and older) in cognitive exercises and creative activities, Creative Fighting of AIDS, a competition for the best multimedia project related to the dangers of AIDS education, Biblical Challenge: Creative Learning of the Bible, a competition for the best multimedia composition including text from the Bible, Creative Reading, a competition involving readers in reading and writing about their reading experiences, and the like. The present invention provides plugins that can be installed on users' sites to provide said service.

Furthermore, the present invention enables optimized multiple matching services for multiple individual users and organizational users. Showcasing users' multimedia compositions, commenting and rating of other users' work, psychological profiles developed based on users' feedback and behavior analysis optimize search of users with specific interests, psychological profile, or any other criteria. Furthermore, organizational galleries providing details on the organizations' products and services enable multiple matching services for multiple organizational users, which include matching corporations, government, and any other types of organizations with potential business partners. The present invention provides plugins that can be installed on users' sites to provide said service.

Furthermore, the present invention enables optimized multiple family and friends searching and strengthening of ties. The users are able to create password protected and/or public folders to post their content, family and friends' materials and share said content. The present invention enables family tree and friends tree development, building and cross-linking individual timelines, and the like. In combination with multiple databases of related materials, databases of links to the online resources, database of templates, and other modules, present invention enables users to strengthen family and friends ties and financially benefit by creating joint pools of advertiser and sponsor links, online family store, and the like. The present invention provides plugins that can be installed on users' sites to provide said service.

Furthermore, the present invention provides multiple customer loyalty services strengthening ties between corporate, government, educational, and any other types of organizations and their customers and individuals. Said services include conducting of online competitions, reality games involving organization's products, lottery for organizations' products and services, and the like. For example, the present invention enables organizations to initiate a competition for the best promotional video, a product improvement solution, and the like. This type of support of creative activities strengthens ties between users and organizations and increases awareness of organization's products and services. Specific examples include, but are not limited to The Best Lawn of the Month contest, sponsored by lawn care businesses, Creative Shopping Challenge, a competition engaging users in creating multimedia compositions related to their shopping experience sponsored by stores, Creative Travel Challenge, a competition engaging users in creating multimedia compositions related to their travel experience sponsored by cruise lines, airlines, travel agencies, and the like, Creative Learning of Safe Driving, a contest engaging young drivers to learn basics of safe driving sponsored by car manufacturers, dealers, and the like, Food for Body and Mind contest, a competition engaging users in creating multimedia compositions related to their dinning experience, sponsored by various types of eateries, and the like. Examples of reality games include Everyday Life Games provided by the present inventions, in which users create multimedia compositions related to their experience with organizations' products or services. Examples of organizations' supported lottery, in which prizes are sponsored by participating organizations, include Shadow Lottery, in which owners of officially conducted lottery tickets can participate with winning numbers determined according to a specified algorithm based on winning numbers of the officially conducted lotteries, for example, plus or minus one, two, or any other number, Creative Lottery, in which users, whose creations are rated above certain level can participate, and the like. The present invention provides plugins that can be installed on users' sites to provide said service.

Furthermore, the present invention provides multiple secrete shopper services evaluating enterprise efficacy, openness to new external ideas, responsiveness to external communication, and the like. The users can post their creations about their shopping, dinning, and other experiences. Particularly, the users can incorporate images and videos related to their experience as a part of the reality game. The users can also receive financial rewards by posting advertisements and sponsor links on their pages. The present invention provides plugins that can be installed on users' sites to provide said service.

Furthermore, the present invention provides multiple recruitment and retention services increasing recruitment and reducing student dropout rate at educational organizations and turnover rate at companies, government, and other types of organizations. Particularly, the present invention enables instructors, managers, and any other person in a leadership position to introduce team aspects increasing responsibility of team members for the success of the team. Subsequently, combining team competitions and rewards, encourages team members collaboration and mutual support. The present invention provides multiple examples of the best practices, for example, online competitions between classes taught by the same or different instructors, in which students post online their homework assignment and special projects, templates, and resources for instructors and participants, and their teamwork is rewarded. The present invention provides plugins that can be installed on users' sites to provide said service.

In accordance with an embodiment of the present invention, the present invention provides multiple identification and promotion of best practices honoring best businesses or individuals services, which may include, posting information about the businesses and individuals on the digital Wall of Honor, Gallery of Fair Players, or any other type of digital gallery. Fore example, instructors can post multimedia compositions about excellent students including images of their tests, links to online projects, videos of interviews, and the like, or companies can post on the Internet or Intranet information about best employees, for example, in the Employee of the Month gallery incorporating image, video-files, and the like. The present invention provides multiple templates for the galleries and means for customizing them or creating own pages for own use and/or for offering for sale and licensing. The present invention also enables generating advertising/sponsor links revenues, part of which can be used to reward individuals, about who information is represented in the galleries. The present invention provides plugins that can be installed on users' sites to provide said service.

In accordance with an embodiment of the present invention, the present invention provides multiple identification and exposure of unacceptable practices, businesses, and individuals services, which may include, but not limited to posting information about the businesses and individuals on the digital Wall of Shame, Gallery of Unfair Players, or any other type of digital gallery. The present invention provides multiple templates for the galleries and means for customizing them or creating own pages for own use and/or for offering for sale and licensing. It enables users to post specific information, including e-mail messages, letters, images, videos and any other proves of misconduct or unfair practices about individuals or organizations. In combination with the gaming module, advertising module, and commerce module, this service provides financial benefits to users and represents a part of reality game. The present invention also provides a fair opportunity for response and comments. For example, when a user, for example, a student, an employee, a neighbor, and the like, posts a low rating and/or negative comments about another user, for example an instructor, a manager, or a neighbor, said user is prompted to provide a contact information for said another user, to whom the corresponding notification is sent to provide a fair opportunity for a response. If a user, who received a low rating was not provided with an opportunity for a response, a corresponding notification is posted. The present invention provides plugins that can be installed on users' sites to provide said service.

Furthermore, the present invention provides multiple market research and business evaluation services. Organizations and individuals can post information on new products and/or services in special galleries. The users reviewing the products, services and/or said organizations can rate them, leave feedback in a form of comments and suggestions, offer improvements, or create multimedia compositions. The users receive feedback points affecting their pay rate for their participation based on the rating of their feedback, value of their comments, and the like. The users can also receive said organization's rewards in a form of products, product discounts, and the like. The present invention provides plugins that can be installed on users' sites to provide said service.

Furthermore, the present invention provides multiple real and virtual travel and food services. The present invention enables users to post images, text, audio, and video information and/or the combination of the information in different formats about their travel or dining experience. Users can create their own galleries showcasing their creations, for example, Travel in Space Gallery, Travel in Time Gallery, Travel in Mind Gallery, Food for Body and Mind Gallery, and the like. In combination with the gaming module, advertising module, and commerce module, the present invention provides financial benefits to users and represents a part of the reality game. The present invention provides plugins that can be installed on users' sites to provide said service.

Furthermore, the present invention provides multiple tutoring services. It leverages capability developed for the training services to provide individualized tutoring in various fields by engaging users in creative activities and learning through creating multimedia compositions. The Present invention provides learning management system (LMS) capabilities, showcasing of tutoring clients' work, rewards, e-portfolios, and other benefits of the present educational gaming environment. It provides a solution to needs of learners of different ages, educational levels, mental capabilities, including home school students, adult learners, and the like: project based learning, service learning, collaboration with peers, and rewards.

Furthermore, the present invention provides multiple physical and psychological training, multiple testing and test anxiety control services. The present invention provides multiple informational resources on different physical training in psychological training systems, including, but not limited to Yoga, Martial Arts, mindful training, and the like. The present invention enables users to learn the training systems by practicing them and creating own materials combining text, image, audio, and video-information about learning experience. Flexibility of the present invention enables users to learn and practice various mind training systems based on modern scientific knowledge, traditional meditation practices, or novel concepts based on neuro-linguistic programming. Users can create their multimedia compositions and collaborate with other users to develop resilience to failure, fight depression, drug and alcohol addictions, suicidal thoughts, and the like. The present invention provides plugins that can be installed on users' sites to provide said service.

In one embodiment of the present invention, the creative activities involving writing about users' feelings and experiences are used for test or performance anxiety control. The users combine writing with images, audio, and video-files and use their multimedia compositions for taking tests in the future by further developing them. In combination with the gaming module, advertising module, and commerce module, these services can provide financial benefits to users and represent a part of the reality game.

Furthermore, the present invention provides multiple lost & found services. The present invention enables users to find friends or any person based on a descriptions, image, and/or video file. The users can participate in the search as a part of a reality game (Search Game). The users can conduct the searches individually or an in a team by joining the Virtual Search Agency, Virtual Police Fraternity, Digital Citizen Order, and other similar teams/organizations. The users can receive rewards for finding or helping to find searched persons or for their multimedia creations reflecting the searching experience in a form of a digital story. The present invention provides plugins that can be installed on users' sites to provide said service.

Furthermore, the present invention enables finding of lost items, for example, personal belongings or any other valuable articles and objects. The users can create and post multimedia compositions including description and pictures of lost and found items or searched objects, including, but not limited to car parts, door handle, that are not readily available from a store. The users help to find lost items and receive Honesty points that are directly linked with the users' pay rate and financial rewards.

Furthermore, the present invention enables finding of poetry, art, music, and other types of information, including, but not limited to partially forgotten pieces, information source, and the like.

Furthermore, the present invention provides multiple inventor services, that may include, but not limited to invention idea evaluation, prototype development, marketing, including, social networking, raising financial support, and other services. In combination with the gaming module, advertising module, and commerce module, this service can provide financial benefits to users and represent a part of the reality game.

Furthermore, the present invention provides multiple intellectual property protection services, which may include, but not limited to search for unauthorized use of the original content, patent and copyright violation, and the like. Users can receive Honesty points for treating intellectual property of other users in an honest way, that increase user's pay rate and can attract advertisers. The present invention provides plugins that can be installed on users' sites to provide said service.

Furthermore, the present invention provides multiple investor services, which may include, but not limited to stock market research, new business opportunities evaluation and consulting, and other services increasing shareholders' value and enterprise efficiency. The users evaluate new technologies, new products, or services that could benefit enterprises in which they invest. The users investing in the same companies can also coordinate efforts in supporting and promoting the companies' products. The companies reward active investors increasing shareholder value by offering stock options, discount to company's products, and the like. The present invention provides plugins that can be installed on users' sites to provide said service.

Furthermore, the present invention provides multiple talent search services, which may include, but not limited to online competitions for the best poetry, art, music, video, scientific paper or any other type of arts or science related original creation. Both organizational users, including, but not limited to schools and colleges, publishers of journals and other periodicals, and the like can organize a competition, showcase participants' entries, assess viewers' rating, automate judging functions, find sponsors, partners, and the like. The present invention provides plugins that can be installed on users' sites to provide said service.

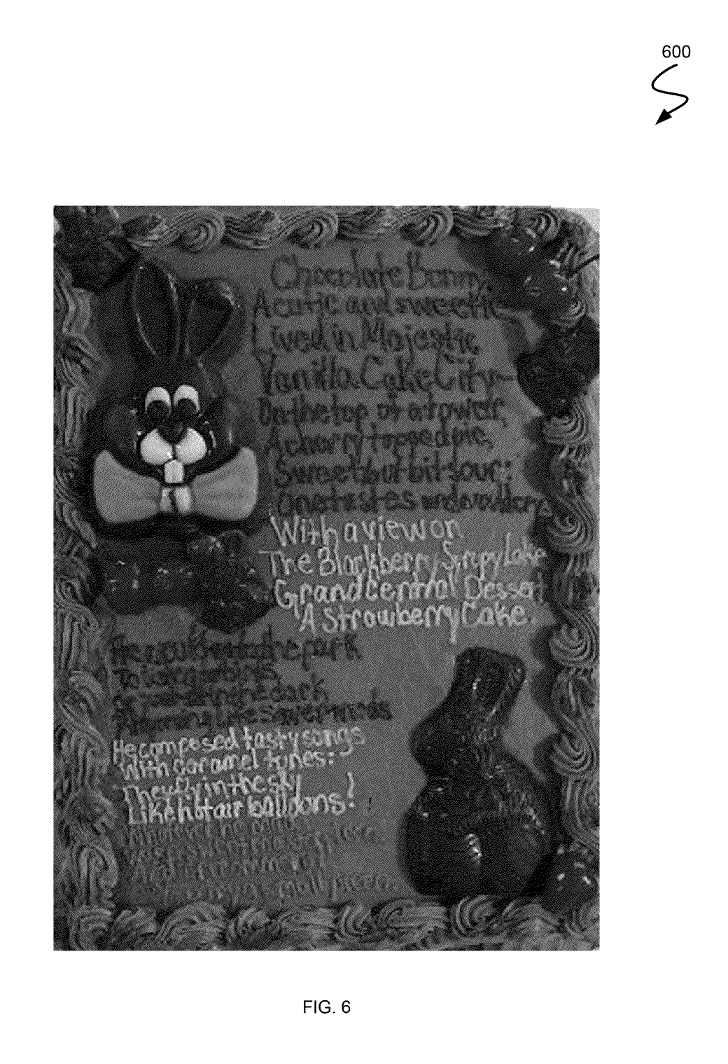

Furthermore, the present invention provides multiple artistic creations evaluation and improvement services, which may include, but not limited to collecting user feedback and suggested improvements to arts, literature, music, and other types of arts, including new creations and old creations. The viewers can rate user created content, offer improvements, provides comments and the like. The collaborators can share financial rewards, jointly promote the improved creation, and the like. The best versions of the multimedia compositions can be combined together, published, and offered for sale. As an example, FIG. 6 shows one embodiment of the present invention representing a screenshot of a children poem written on a cake with sweet colors. As a part of a competition for the best illustrations and music to a digital children book based on the poem (Sweet Poetry), users can offer their illustrations and music, as well as animations created by using sweet colors, chocolates, cake decoration materials, and the like. The owner of the original content can select the best entries based on the popular rating or his/her own judging panel advice. The present invention provides plugins that can be installed on users' sites to provide said service.

Furthermore, the present invention provides multiple mail and e-mail delivering services. The users send e-mail messages to the central database where a copy of the message is stored. The message logged in and forwarded to the original addressee with the priority degree determined by the user. A response from the recipient is evaluated for timing, and completeness of addressing questions raised in the original message. Moreover, the response is published for public view if this option is selected by the original user or the respondent. Response index is calculated according to a specified algorithm including and published in a searchable database. The present invention provides plugins that can be installed on users' sites to provide said service.

Furthermore, the present invention provides multiple web design services, which may include, but not limited to, design of individual and organizational e-portfolios, timelines, trading cards, flash cards, strategy gaming cards, and any other type of Web-based information, and multiple commerce services, which may include, but not limited to enabling financial transactions, offering users' content for sell and licensing. In combination with other modules provided by the present invention, the Web based information enables users to provide various services including, but not limited to training services, tutoring services, and the like.

As a part of modules provided by the present invention, the present invention also provides plugins enabling users to embed multiple modules and offer the services on the users' Web sites or provide links to users pages hosted on third parties' web sites, including, but not limited to social network sites, web hosting providers' sites, and the like. The users can obtain said plugins free of charge, for a fee, or as a part of a paid membership depending on the type of plugins and type of users, including a paid member of a user group, which can include, but not limited to user association, federation, and the like, cooperative, franchise, and the like.

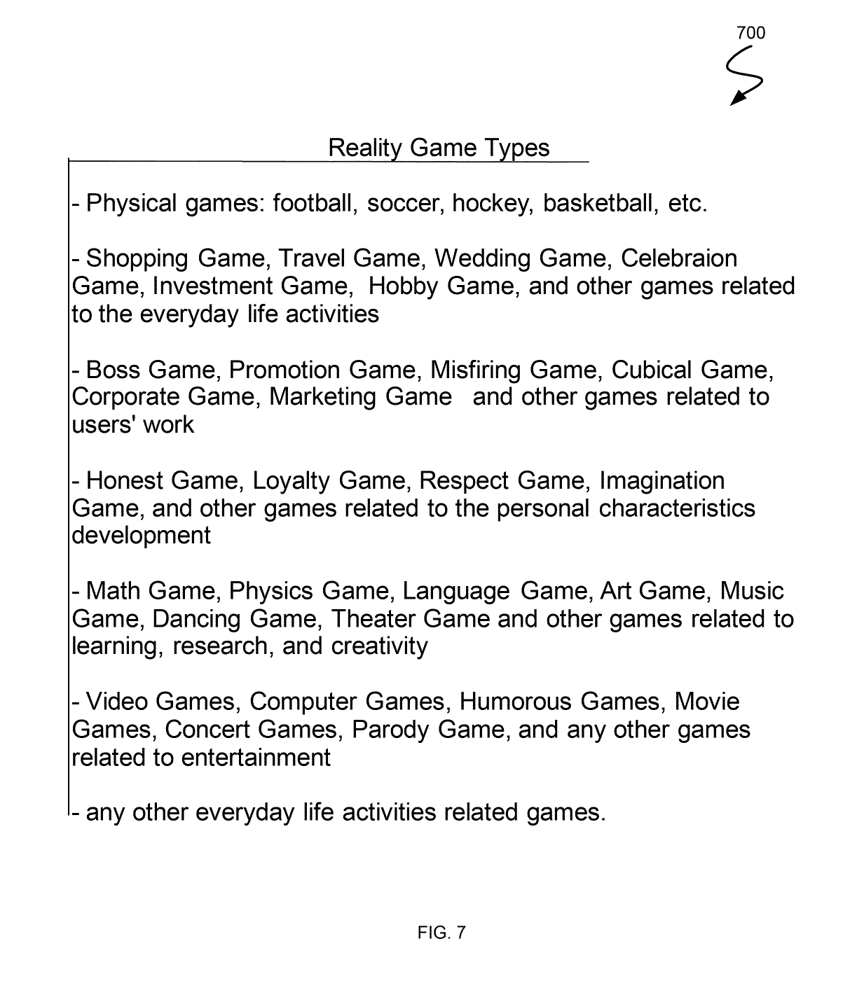

FIG. 7 illustrates a schematic diagram 700 illustrating one or more types of Reality Game, according to one embodiment of the present invention. The gaming module 35 is configured to enable the one or more users to incorporate multiple gaming or real life activities in their multimedia compositions produced on individual or team level as a part of Role Playing Game (RPG), RPG Forum game, which include, but not limited to everyday life activities based games as illustrated in FIG. 7 of the present invention. The everyday life activities based games include Shopping Game, Travel Game, Wedding Game, Celebration Game, Investment Game, Hobby Game, and the like; work activities based games: Boss Game, Promotion Game, Misfiring Game, Cubical Game, Corporate Game, Marketing Game, and the like, personal characteristics development games: Honest Game, Loyalty Game, Respect Game, Imagination Game, and the like, learning, research, and creativity based games: Math Game, Physics Game, Engineering Game, Language Game, Art Game, Music Game, Dancing Game, Theater Game, and the like, and entertainment activities based games: Video Games, Computer Games, including games with a computer targeting development of artificial intelligence algorithms, software improvement, and the like, Humorous Games, Movie Games, Concert Games, Parody Game and the like.

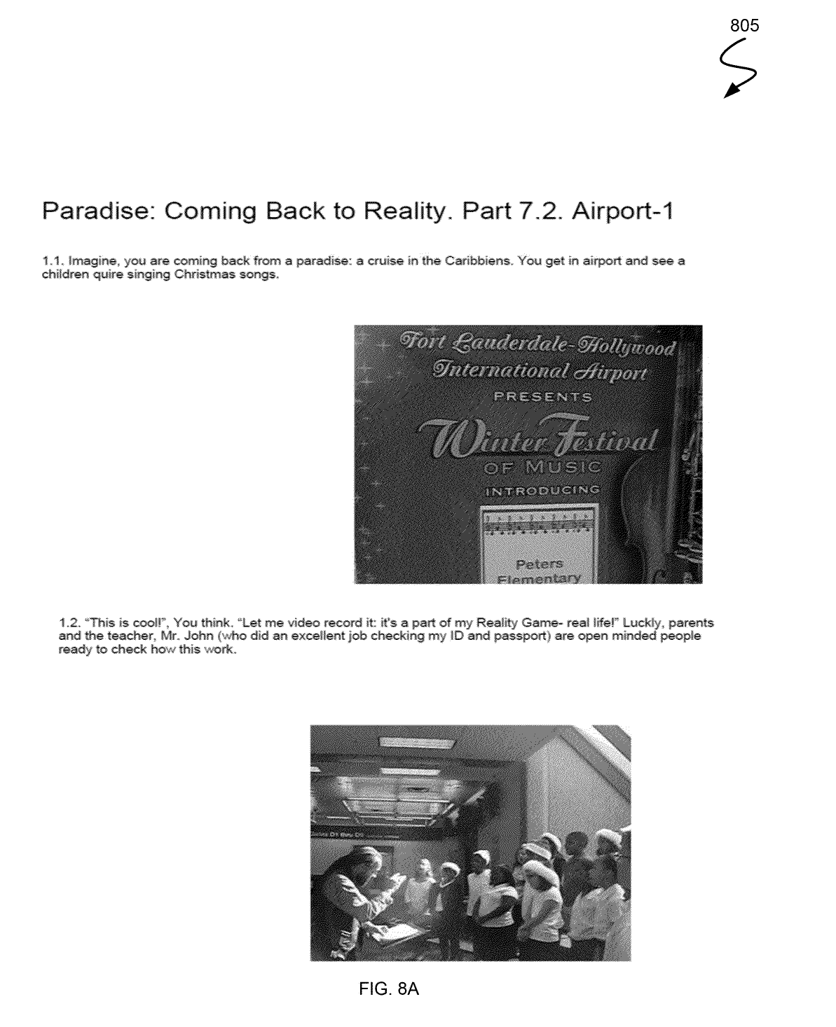

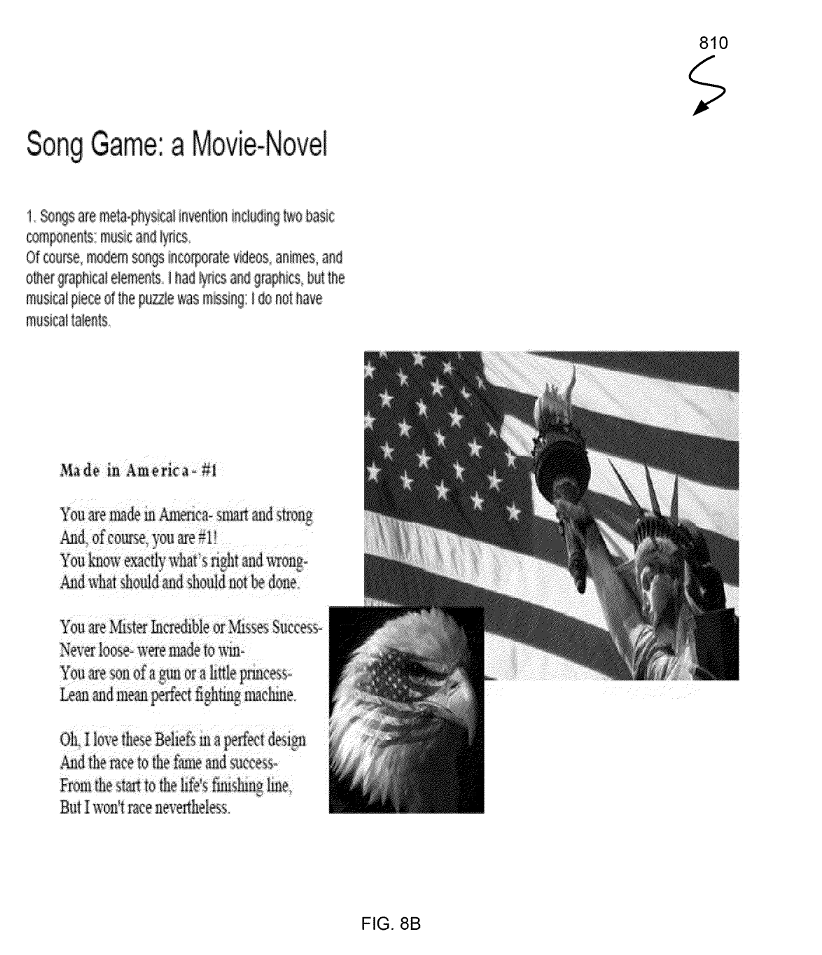

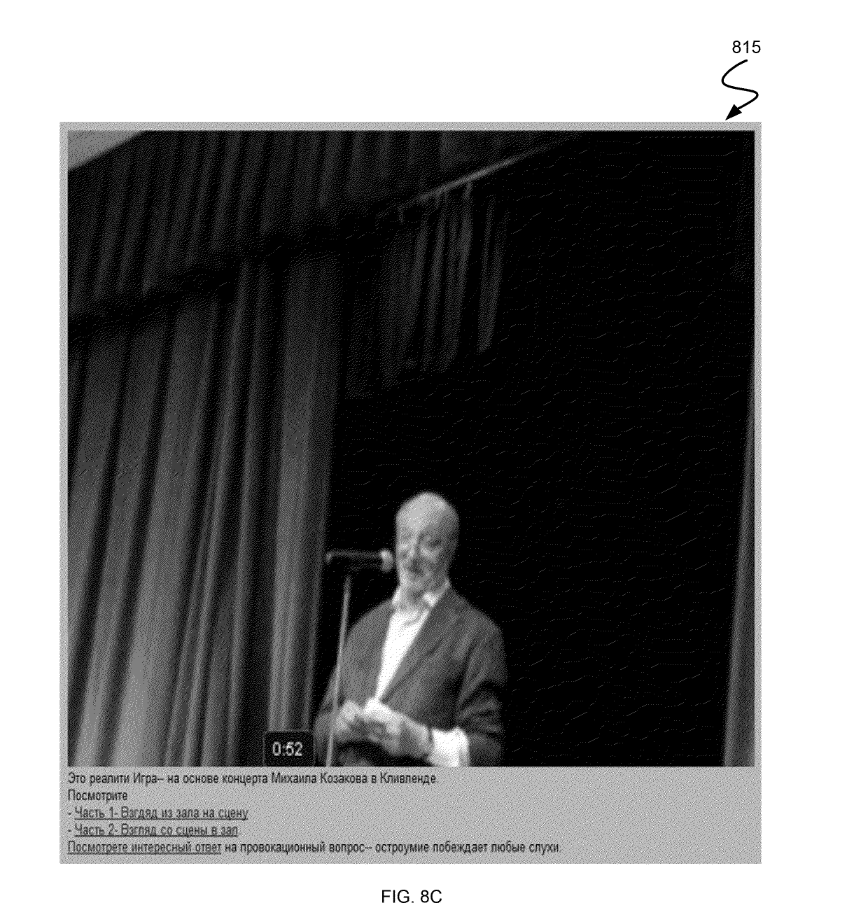

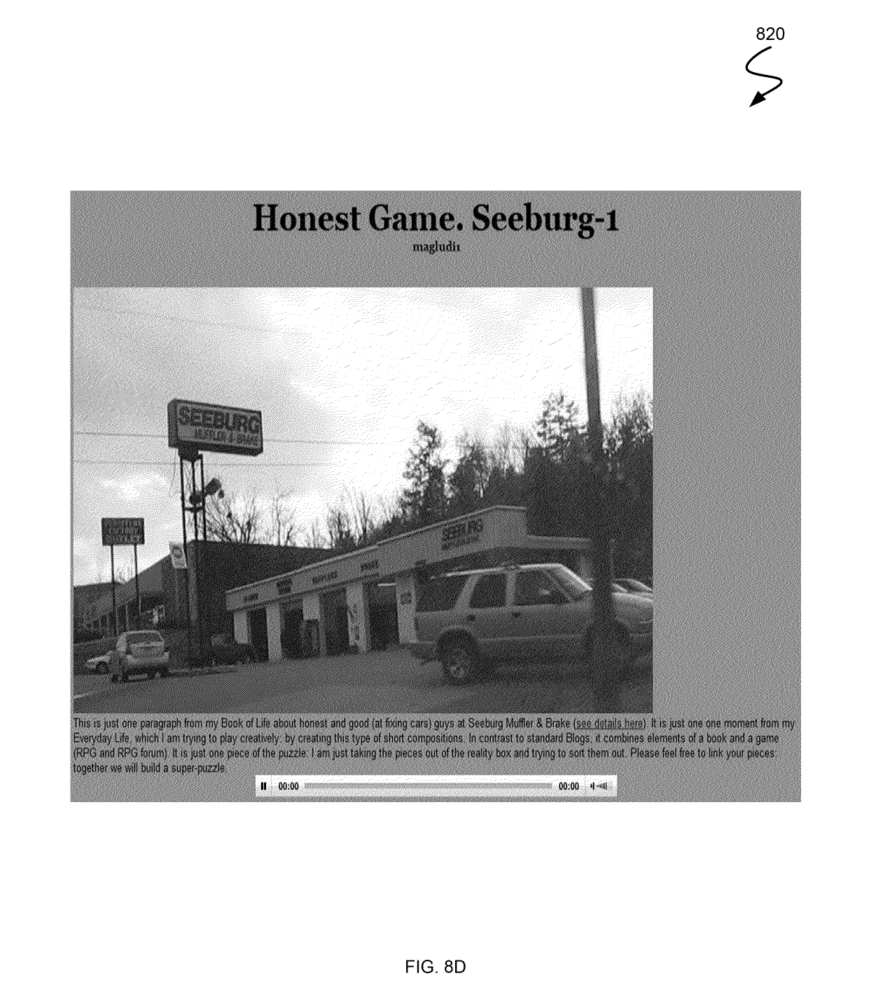

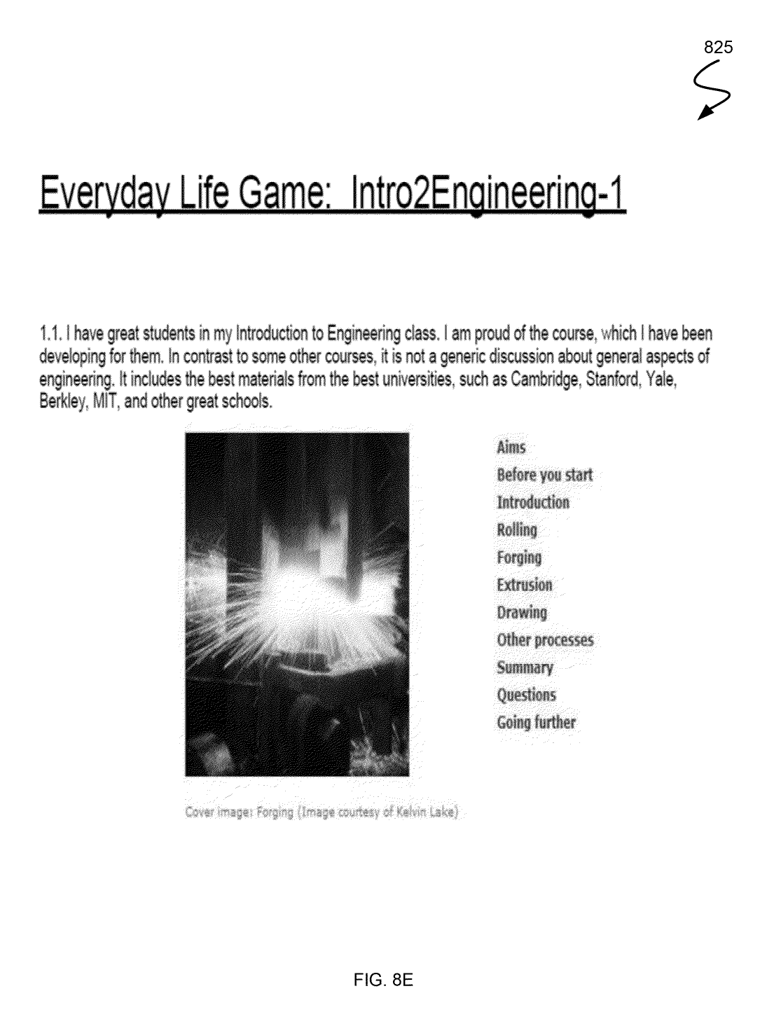

FIG. 8A illustrates a screenshot 805 of an RPG Forum game exemplifying a Travel Game, FIG. 8B illustrates a screenshot 810 of an RPG Forum game exemplifying a Music Game, FIG. 8C illustrates a screenshot 815 of an RPG Forum game exemplifying a Concert Game, FIG. 8D illustrates a screenshot 820 of a RPG Forum game exemplifying a Honest Game and FIG. 8E illustrates a screenshot 825 of a RPG Forum game exemplifying an Engineering Game, according to one embodiment of the present invention. Said games represent a combination of a Blog, book, and a game and provide users with a flexible format for expressing thoughts, ideas, and feelings, documenting events of personal life or organizations' everyday operations, with rewards linked to users' creativity, learning, and positive behaviors. Said flexible format provided by the present invention enables users to incorporate any real life events, any games, including alternative reality games, sport games, any type of arts in their multimedia compositions. It enables users to express their views on serious life questions, including questions about meaning of life, aim of existence, and the like in a humorous and succinct form. For example, users can utilize Bullet Proof Format enabling them to present textual components of the multimedia compositions in a form of short sentences (bullets) and/or a Parody of a Parody format to incorporate humor. Users can also incorporate elements of the Principle Game, including principles of designing users' games. Said game design principles include, but are not limited to Yes/No-ism (Universal Yin/Yang) Principle enabling expressing ideas in a form of contradictions representing, for example, balanced/non-balanced statements/not-statements, Rotation of Vector of Polarization of Ideas Principle, enabling expressing ideas from different points of views, Principle of Equilibrium Mistakes, enabling expressing ideas in a humorous way, for instance, incorporating mistakes reflecting different accents, including, but not limited to the Russian, French, Chinese, and other accents, Five Element Design Principle, and the like.

In one embodiment of the present invention, the user plays the one or more reality games in a first shooter format, second shooter format, and/or third shooter format. Moreover, the created multimedia compositions reflect everyday life of the user from the first person perspective, second person perspective, and third person perspective, respectively. Person, whose perspective is adopted to play a game, is selected from a group including a real person, a character, or multiple characters introduced by the player or other players. The users receive honesty points, integrity points, and the like affecting their pay rate. In use, the game is designed to incorporate any existing games through a RPG Forum wherein users create multimedia compositions related to any other game including screenshots, videos, stories, etc. The game further incorporates a Universal score including a weighted average of scores from one or more games. The game is played at individual level and/or team level. In practice, at an individual level, the user creates an account and starts as an apprentice and selects at least one avatar from the one or more databases of the present invention or builds own avatar. The user completes one or more tasks (challenges), including creation of multimedia compositions, and the user advances to the next level (master) achieving a certain score, for example, creating ten 5-star rated multimedia compositions. In operation, the score is a weighted average of user scores reflecting creativity, learning, community service, collegial behavior, and scores from other games. Generally, the user's pay rate is proportional to the score. Subsequently, the user receives credit points at each level and buys gaming gear or SIM's components to customize user's environment. The users gain financial rewards through posting advertisement and sponsor links on their pages, licensing an original content, selling their creations through online shop or auction, competitions, sweepstakes, lottery, and the like.

Generally, at a team level, additional features are provided, wherein the team creates an account, and the team selects an emblem and team avatar. Then, the team completes various tasks, including creation of multimedia compositions on different subjects, such as mathematics, physics, arts, etc. or passing tests on different topics of the same subject, for instance, linear functions, quadratic functions, etc. in algebra. Subsequently, the team advances to the next level achieving a certain score, which is a weighted average of all team members' score, and the team's pay rate is proportional to the score. Also, the team receives credit points at each level depending on the number of players and their individual score and buy gaming gear or SIM's components to customize team's environment. The team gains financial rewards through the above mechanisms, with rewards distributed between team members equally, or according to the score of individual members or in any other way adopted by the team members. Generally, the reward mechanisms for teams are optimized to increase efficiency of team work, retention of team members in class, college, or any other organization, rewarding team coaches, for example, instructors or managers adopting innovative ways to improve efficiency of learning or company operations.

In use, the reality game is played in the RPG Forum format or through creating multimedia compositions reflecting users' life experiences, including, user (or users if played on the team level) creating its own characters, creating multimedia compositions by combining text, image, audio, and video files using pieces from databases (including, relational databases) provided and/or Web resources, incorporating challenge questions or links helping viewers to learn different subjects, engage them in user's game, calibrate response for the future improvement of the user's game and viewer's gaming experience, and generate financial rewards. Consequently, the user modifies and develops the game according to the feedback received.

In accordance with an embodiment of the present invention, user progress in the game is reflected in a form of a Life Road (timeline). The users are provided with capabilities to customize their individual Life Roads (timelines) by using, for example, SIMs or any other graphical and animation programs. Moreover, the users can link their characters to their characters created in other games. Users can manage their teams of characters by merging their characters, sharing their abilities and scores, and the like. Users can use points earned in the game to create clones of their characters, buy gaming gear, create armies of soldiers, robots, and other types of real characters and fictitious creatures.

In accordance with an embodiment of the present invention, the system 100 further includes an authoring module, a simulation module, a learning management module, a family tree module, a service matching module, a corporate learning module, and a player's module (not shown).

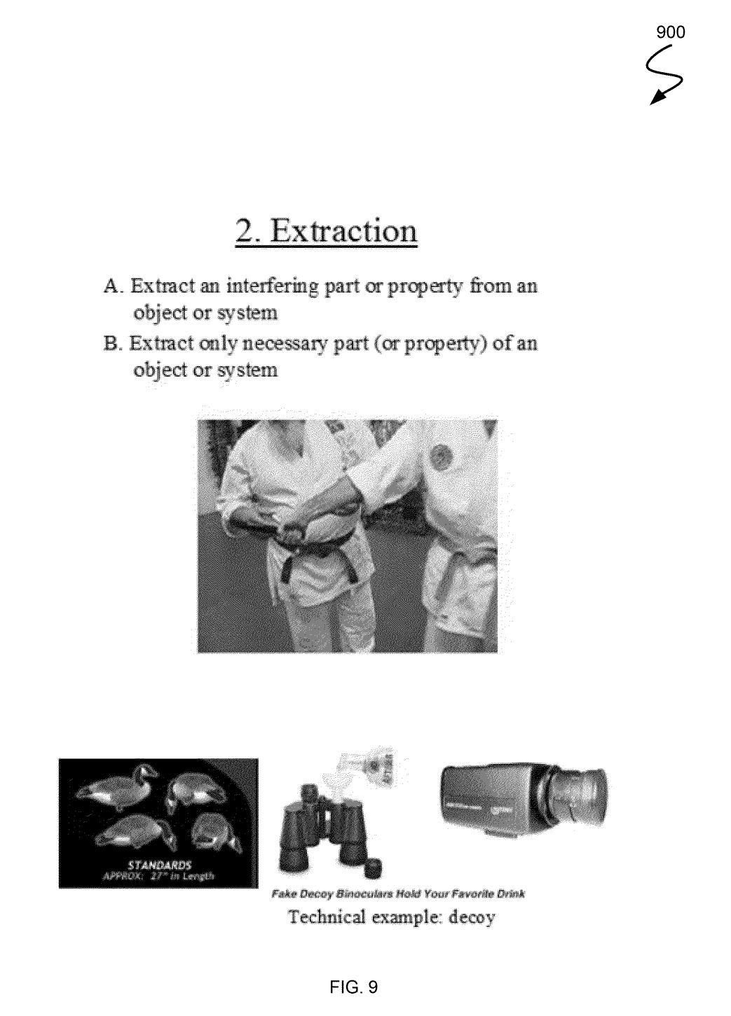

Consequently, the present invention provides capabilities to incorporate various learning and creative activities in a form of an educational gaming environment. As a specific example, FIG. 9 shows a screenshot 900 of a page from a tutorial on innovation aspects of Martial Arts. The present invention enables users to learn bio-mechanics of martial arts, by using the one or more databases for storing text, images, videos-files with martial arts techniques, and a second database for storing text, image, audio, and video-files for mind full training of the users, and the like and creating their own multimedia compositions. The users can incorporate their own videos and images from practicing Martial Arts as a part of the Everyday Life Game, progress through the ranks and reflect the progress in a form of the Life Road, and receive financial rewards through mechanisms provided by the present invention. Similarly, users can learn any sport and incorporate their experiences in their multimedia compositions.

In accordance with another embodiment, the present invention provides a set of intellectual games involving users in active development of thoughts and ideas offered by the users or other users. In one implementation, a user selects the size and type of the digital (virtual) game board from a set of provided customizable templates or creates own game board. The user then configures the game settings, including but not limited to, allowed types of information that be used in the game, difficulty level, game monitoring settings enabling the user, who started the game to reject and delete information pieces posted by other users, specify allowed number of users, and the like. The user then posts a seed idea expressed in a form of a text, image, audio, video-information or any their combination on the game board. The user or other users add their thoughts and ideas expressed in forms allowed by the game settings by placing them in various areas of the game board. Subsequently, the present invention provides means for keeping track of the ownership, time, and any other information related to the posted information piece. Furthermore, the present invention provides means for rating of each piece of information by viewers and means of re-arranging placed information pieces according to the rating, chronological order, Creativity index, Novelty index, or any other parameter or any other criteria selected by the originator of the game as specified in the game settings. Also, the present invention provides means for graphical representation of the development of the original idea in one or more forms including, but not limited to Idea tree, wherein the information pieces are grouped in categories and are connected to represent relationships evolved with time and Idea map, wherein the information pieces with the same rating, number of citations, Creativity index, Novelty index, or any other user defined parameter are connected to produce contours. In these and other similar forms reflecting relationship between information pieces, the ideas are represented by a number, letter, brief description, or in any other way with links provided to multimedia compositions, Web sites, or any other sources of detailed information on the ideas.

In another embodiment of the present invention, the intellectual games are directly linked to TV programs, including, but not limited to educational programs, talk shows, reality shows, and the like. The content of the programs and supporting materials are made available to users for creating their multimedia compositions related to the topic of the program. The one or more users select advertisement and sponsor links provided in the one or more databases related to the program for posting on their pages. The reward module 36 includes a licensing sub-module. The licensing sub-module is configured to enable authors of the original content to receive licensing fees as a specified percent of the total revenues generated by the links posted on the users' pages.

In one embodiment of the present invention, the users create digital puzzles, digital collages, and play any other digital games or conduct any other activities involving assembling pieces of information in a text, graphical, audio, and video formats together. Moreover, the present invention provides means for choosing level of originality, difficulty, complexity, and other characteristics of produced multimedia compositions, sets of puzzle pieces and puzzle piece components, sets of examples and templates designed for users of different age, ethnic and educational background, and the like.

In one embodiment of the present invention, at the originality level 1 of the game, the one or more users use existing pieces of information in one or more formats to create the multimedia compositions. Moreover, the users select the difficulty level, for example, difficulty of mathematical problems or physics equations incorporated into their compositions depending on their interests or tasks assigned, for example, by instructors, mentors, or the like. Subsequently, at the originality level 2 of the game, the users incorporate their own creations and pieces of information along with the existing pieces. The one or more users select the difficulty level, for example, difficulty of a problem addressed in an essay, a textual component of the multimedia composition, or difficulty level of its solution (depth of analysis).

At the originality level 3, the users use their own original materials to create the multimedia compositions. Particularly, the present invention provides a set of algorithms for determining the level of originality based on information provided in forms, certain formulas, viewers' rating, experts' rating, and the like. Moreover, the present invention provides a set of forms for collecting information determining the level of originality of user creations and displaying said information characterizing the level of originality (formulas of inventions). The one or more forms are customized for different types of user creations, ranging from actual physical inventions to abstract ideas and artistic creations including meta-physical inventions. The level of originality is considered in calculating Creativity Index of a user, or a team of users. For example, Creativity Index (Creativity IQ) of a residential facility, a residential sub-division, and the like is calculated based on a rating of creations by the residents, with information about said Creativity Index provided to individuals interested in buying a real estate in subdivisions with active social life and creative activities. Similarly, Creativity Index of a pre-school, school, college, or any other organization can be calculated.

In one embodiment of the present invention, multimedia compositions are segmented into pieces of puzzle with the audio file segments associated with each piece of puzzle. The player connects the pieces by puzzling together the right sequence of music segments. Consequently, the present system 100 is used for enhancing auditory senses and memory, as well as by individuals with impaired visions for learning and creating digital art.

In another embodiment of the present invention, text associated with the puzzle pieces of the multimedia composition is a set of mathematical problems, quiz questions, or any other type of challenge questions. If the user provides the right answer, an image associated with the corresponding piece of the multimedia composition, an audio component, or both image and the audio component are revealed.

In yet another embodiment of the present invention, the multimedia composition is used as a piece for a digital collage. The present invention provides a set of tools for assembling the multimedia in collages positioning them in certain places. The user selects the position of each piece from a set of options, by introducing multiple coded coordinates, or by dragging the piece to a desired location. The users receive viewers' feedback. The viewers' feedback includes rating, and suggestions about the best position of the multimedia composition in the collage. The optimization of arrangements of textual, audio, image, or video components or their combinations is used in developing the collage.

In yet another embodiment of the present invention, the user creates multi-layer collages, overlapping collages positioning them in each layer based on a set of criteria, including, but not limited to aesthetic, chronological, or any other considerations. The present invention provides means for adjusting transparency of the layers, and designing layers resulting in the Moire pattern.

In yet another embodiment of the present invention, present invention enables the users to specify pattern of moving collage pieces from one layer to another, switching text, image, audio, and video-components between multimedia compositions in one layer or between layers. The one or more algorithms determining the moving patterns include random switching of multimedia compositions or their components, moving pieces according to a number of predetermined algorithms, or specified by the user.

In yet another embodiment of the present invention, the present invention enables users to incorporate their multimedia compositions in digital versions of various games, including, but not limited to the board games, including, but not limited to chess, checkers, Battleship, Monopoly and the like.

In yet another embodiment of the present invention, the present invention enables the users to incorporate user created multimedia compositions in various card games, including, but not limited to, digital versions of learning card games, playing card games, trading card games, card-based strategy games, and the like. In one specific example, user created cards featuring great mathematicians, physicists, and other type scientists, artists, musicians, and the like can be used in a digital version of the Guess Who? game. In another specific example, user created cards featuring great inventions, places, historic events can be used in digital versions of Guess What? game, Guess Where? game, Guess When? game, correspondingly.

Particularly, the advertising and sponsor links are added to the digital trading card, the owners of the card receives a portion of the advertising and sponsor links revenues calculated according to a specified algorithm taking into account number of views of the card posted by the owner, rating of the card and rating of changes introduced by the owner, reference index of the card (number of cards developed based on said card), citation index (number of links to the said card), and the like.

In yet another embodiment of the present invention, the card-based strategy games, the attack and defense powers of the card is determined based on its rating, number of views, number of defeated cards in previous games, and other parameters used to evaluate the powers according to specific formulas or users receive one or more abilities to view opponent's cards, rearrange, capture and the like. The one or more users with a certain high score of learning and teaching multimedia compositions print out or order a sticker that is attached to the surface of a regular strategy game card. The sticker enables player's specific abilities, increase attack or defense powers, increase healing powers, and the like.

Consequently, the present invention provides a set of tools for incorporating user created multimedia compositions in existing digital versions of various table games and new modification of these games including different configurations of multimedia compositions and their components in response to actions in the game. Other examples of digital version of popular table games provided by the present invention through incorporating user created multimedia compositions with a configured response to game actions include, but not limited to Battleship game, Battleball game, Guess Who?, Guess What?, Guess Where?, Guess When? games, Tic-Tac-Toe game, various types of card games, and the like.

In yet another embodiment of the present invention, the present invention enables the one or more users to incorporate various sport and physical activity games in their multimedia compositions.

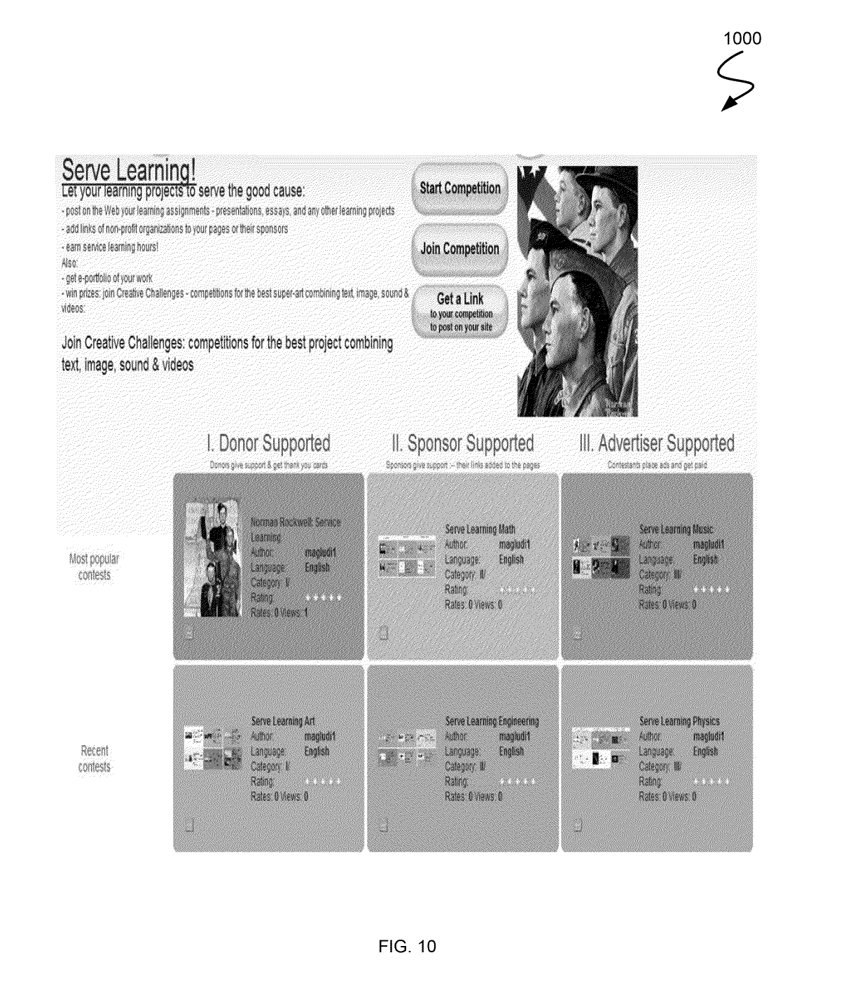

In one embodiment of the present invention, the users create multimedia compositions about their favorite games, players, coaches, and any other aspects of the game or their own involvement. The one or more users post their multimedia compositions on the Internet and add links of non-profit organizations to support the cause or links of sponsors giving donation to the non-profit organizations. The users receive community service points and learning service hours based on the score of the compositions, time users spent to create said compositions, and other factors. As an example, FIG. 10 illustrates a screenshot 1000 from a Serve Learning gallery hosting user creations including links of non-profit organizations. The users also receive financial rewards enabled by other modules provided by the present invention.

In accordance with another embodiment of the present invention, the present invention provides the method for project based learning and service learning, which includes the steps of creating at least one multimedia composition by the at least one user, accessing the at least one multimedia composition by the at least one user, retrieving at least one of an advertisement and a sponsor data from at least one database of multiple databases and executing a set of instructions to combine the at least one multimedia composition and the at least one of the advertisement and the sponsor data from the at least one database.

In accordance with another embodiment of the present invention, the method further includes retrieving at least one of a non-profit organization data from the at least one database of the multiple databases and executing a set of instructions to combine the at least one multimedia composition and the at least one of the non-profit organization data and the sponsor data from the at least one database.

In accordance with another embodiment of the present invention, the method further includes incorporating the at least one multimedia composition in at least one of an e-portfolio, an RPG, a RPG Forum game and the like.

In accordance with another embodiment of the present invention, the method includes retrieving the at least one multimedia composition for participating in or conducting at least one competition for a best multimedia composition and determining at least one partner and at least one sponsor for the at least one competition. Said project based service learning method can be incorporated into a standard teaching practice and serve as a basis for development of novel teaching approaches as well. For example, an instructor can review homework assignment problems and provide solutions in class. As a homework assignment, learners create their own problems by modifying the original problems and providing solutions for their versions of the problems. Learners post their problems and solutions online enabling other learners to learn from their work (home assignment projects), that serves learning community as an important learning resource. Said learners can also post links of non-profit organizations on their pages thereby increasing awareness about the good cause projects. Furthermore, said learners can also post links of sponsors providing support to said non-profit organizations thereby helping said non-profit organizations to raise funding. Furthermore, the present invention enables sponsors to increase efficiency of their marketing and charity initiatives by combining online advertising budget and charity budget, building relationship with the community by providing support to their customers, and efficiency of sponsors' recruitment efforts by identifying and supporting learners with needed talents and skills. Thus, the present invention provides a new project based service learning method increasing efficiency of learning through projects of different scale, ranging from simple home assignments to complex course projects and theses, and providing different types of service to the community benefiting learners, non-profit organizations, and their sponsors.

In accordance with another embodiment of the present invention, the present invention provides a self-multiplying advertisement system and method, wherein a user selects an advertisement from a database, which has “a copy to” field enabling user to specify a particular multimedia composition or any other user creation on which the advertisement will be posted, and/or a database of user selected advertisements or links to the advertisements. The users specify time period, size, location, and other parameters determining the manner of displaying the advertisement, including, but not limited to blinking, moving along the page, and the like. Additionally, advertisements of one specific product, service, company, or any other organization is displaced in a form of a strip, rotating images displayed in a sequential manner, or any other way attracting attention of viewers. Also, the control module 22 associated with the advertisement enable determining the content of the user pages for inappropriate words, images, and the like, and the control module 22 send messages to the owner of the advertisement, copy of which is requested, including warning messages when inappropriate content is detected, as well as to the user, who requested a copy, particularly, a notification of a rejection when the inappropriate content is detected. Moreover, statistics related to the number of clicks and copies of the original advertisement is stored in a file, and URL addresses of hosting pages are stored in the searchable databases of the present invention. Therefore, the user has a choice to allow updates to the posted copies, including changes to the original advertisements, which are automatically incorporated in the copies. The user further has a choice to allow statistical information of clicks and copies of the advertisement posted on the user pages to be shared with the original advertisement. The analytics module 30 associated with the original advertisement enable determining copies with the highest number of clicks and completed transactions. Henceforth, the system 100 and method is self-multiplying, whereby copies to the player's ads database when put on the pages determine page content and keeps statistics, and further provide rewards to owners of copies with the highest number of clicks and completed transactions, subsequently sending a percentage of sales or certain fixed amount to non-profit organizations. The present invention provides a plugin enabling users to incorporate said advertising system on their web sites, said plugin configured to be compatible with the text box with extended functionality enabling optimized word processing, including, but not limited to word overlapping, assuming specified shape, keeping track of changes, incorporating gaming elements, calculating citation index, humor index, and the like.

Therefore, as can be seen, various embodiments of the present invention provide multiple advantages over prior art, such as, for example, but not limited to, providing training services to users, which include novel content and allow the users to learn from studying the materials and creating their own multimedia compositions. The training services further provide new partnership arrangements between participating parties, and provide additional and improved gaming elements.

Those of ordinary skill in the art will appreciate that various embodiments of the present invention disclose innovative and improved aspects, including, but not limited to tutorials on Macro- & Micro-Innovation, multiple methods of systematic analysis, including, but not limited to universal TRIZ, which is applied to physical (technical) and meta-physical (non-technical) inventions, morphological analysis which includes morphological matrix of invention and methods relying on creative “out-of-box” thinking. A metaphoric analysis includes matrix of metaphors, which includes database of text, image, sound, and video-files that represent examples that be used as analogies. The invention also provides sympathy methods including templates of digital storylines enhancing creative thinking, and the like. The present invention eliminates limitations of educational systems relying on standard teaching approaches and incorporates modern didactic principles of project based learning, engaging learners in creative activities, and hands-on learning that significantly improve learning outcomes. Moreover, the present invention provides a learner centered gaming environment with new capabilities for service learning increasing value of student work beyond the grade and for creative activities. Those of ordinary skill in the art will further appreciate that various embodiments of the present invention differ significantly from the prior art, and provide additional features such as cloud sourcing wherein users add their pieces; rating; reward through ad/sponsor links, competition prizes, and the like.

1. A system for providing education and a plurality of creative activities to at least one user in a project based and service learning gaming environment, said system comprising:
a central processing unit, a set of support circuits and at least one server computer for communicating over a communication network, said server comprising:
at least one processor configured to execute at least one set of instructions for providing educational and a plurality of creative activities to said at least one user in said gaming environment;
a memory device coupled to said at least one processor, said memory device comprising a plurality of modules configured to enable said at least one user to create at least one multimedia composition selected from a group comprising a multimedia composition composed individually, a plurality of multimedia compositions composed in at least one team, and the like, conduct e-commerce in said gaming environment, and provide an interactive learning environment to said at least one user via said communication network and at least one of a plurality of databases and a plurality of links each associated with said plurality of databases, having stored therein said at least one set of instructions for execution by said at least one processor for providing education and creative activities to said at least one user in said gaming environment; and
an interface to provide access to said server from a plurality of client devices over said communication network;
wherein said system is configured for providing an increased efficiency of learning and creative activities and optimized user experience.

2. The system as claimed in claim 1, wherein said plurality of databases comprise a multimedia database, a scientific information database, a historic information database, a player database, a non-profit organizations database, a for-profit organizations database, a mentoring and consulting database, a projects database, a tutorial database, an advertisements database, a gaming database, a players' societies database, a tests database, a competitions database, a templates database, a polls database, a mental exercise database, a database of materials for expressive therapies, and a rewards database.

3. The system as claimed in claim 2, wherein said system is characterized by:
said multimedia database comprising a plurality of pieces of literature, art, music, and films, a plurality of links to said plurality of pieces of information in different formats, and a plurality of multimedia compositions produced by combining said plurality of pieces of information by said at least one user;
said scientific information database comprising scientific information in at least one format comprising text, image, audio, video, and the like;
said historic information database comprising historic information related to history of a plurality of individuals, a plurality of organizations, a plurality of cities, a plurality of countries, and the like;
said player database comprising a plurality of user names, said plurality of user names are selected from a group comprising a plurality of organizational users, a plurality of names of user created characters for RPG and RPG Forum games, and a plurality of names and titles of user created multimedia compositions;
said non-profit organizations database comprising information related to educational, health related, religious, government, and any other type of non-profit organizations accepting monetary, non-monetary, any other type of donations and the like; and
said for-profit organizations database comprising information related to for-profit organizations, non-profit, government, and any other type of organizations providing monetary, non-monetary, any other type of donations and support to non-profit organizations, individuals and the like.

4. The system as claimed in claim 2, wherein said system is characterized by:
said mentoring and consulting database comprising information related to a plurality of experts in at least one field capable of providing mentoring, consulting, or any other type of support to said at least one user;
said projects database comprising information related to a plurality of projects, said plurality of projects comprising design, market research, and other type of educational, as well as non-educational projects facilitating development of design, innovative thinking, and other useful skills and socially responsible attitudes;
said tutorial database comprising a plurality of tutorials related to at least one field, said at least one field comprising at least one tutorial on a plurality of disciplines, a plurality of arts, a plurality of sports, a plurality of innovations, safety, other areas of corporate, school, individual learning and activities and the like;
said advertisements database comprising information related to text, image, video, and any other types of advertisements;
said gaming database comprising educational and non-educational games comprising a plurality of online games, a plurality of video games, a plurality of sport games, and any other type of physical and non-physical games;
said players' societies database comprising information related to gaming societies, interest groups, and other types of associations of users according to their interests;
said tests database comprising information related to tests comprising a plurality of tests in at least one discipline, physical and psychological tests, and any other type of tests designed for individuals and organizations; and
said competitions database comprising information related to online and any other types of competitions.

5. The system as claimed in claim 2, wherein said system is characterized by:
said templates database comprising a plurality of templates of multimedia compositions and documents, said plurality of templates of multimedia compositions and documents comprising legal documents, financial documents, honor diploma, thank you cards, e-cards, individual and organization timelines, web sites, web design components, e-portfolios, and the like;
said polls database comprising information related to a plurality of polls and any other type of user provided feedback information;
said mental exercise database for storing at least one type of puzzle, said at least one type of puzzle comprising a multimedia puzzle, a crossword, and other intellectual activities information;
said expressive therapy database comprising a plurality of resources for art, music, poetry, other types of expressive therapy, mindful training and the like; and
said rewards database comprising information related to rewards, including monetary, non-monetary, and any other types of rewards.

6. The system as claimed in claim 1, wherein said system further comprises a plurality of multimedia modules for creating and showcasing said plurality of multimedia compositions, particularly, in a form of online competitions initiated, managed, and conducted by individual or organizational users, said plurality of multimedia modules comprising a content management module and a content processing module enabling text, image, sound, video processing, and plugins enabling said at least one user to utilize functionality on said user web site.

7. The system as claimed in claim 1, wherein said plurality of modules further comprises a user management module, a collaboration management module, a social interaction management module, a control module, an analytics module and a conflict resolution module, including plugins enabling said at least one user to utilize functionality on said user web site.

8. The system as claimed in claim 1, wherein said plurality of modules further comprises a commerce module, a reward module, and an advertising module said reward module is configured to provide financial incentives in a form of revenues derived from advertising and sponsor links posted on said at least one user interface, licensing fees, competition prizes, and selling of an original content and non-financial incentives, said original content and non-financial incentives comprise diploma certificates, and the like and reflecting service hours and community service points evaluated according to at least one algorithm by said commerce module, including plugins enabling said at least one user to utilize functionality on said user web site.

9. The system as claimed in claim 1, wherein said system further comprises a gaming module, an artificial intelligence simulation module, a customization module, and an optimization module, including plugins enabling said at least one user to utilize functionality on said user web site.

10. The system as claimed in claim 1, wherein said plurality of modules further comprises a commerce module configured to facilitate a plurality of services, wherein said plurality of services comprise a plurality of training services, a plurality of enhancing project based and service based learning services, a plurality of services for conducting online competitions, a plurality of matching services for said at least one user, a plurality of matching services for a plurality of organizational users, a plurality of services for family and friends searching and strengthening of ties, a plurality of organizational loyalty services, a plurality of customer loyalty services, a plurality of recruitment and retention services, a plurality of identification and promotion of best practices honoring best businesses or individuals services, a plurality of identification and exposure of unacceptable practices, businesses, and individuals services, a plurality of market research and business evaluation services, a plurality of secret shopper services evaluating enterprise efficacy, openness to new external ideas, responsiveness to external communication, and the like, a plurality of real and virtual travel and food services, a plurality of tutoring services, a plurality of physical and psychological training services, a plurality of testing and test anxiety control services, a plurality of lost & found services, a plurality of inventor services, a plurality of investor services, a plurality of talent search services, a plurality of intellectual property protection services, a plurality of artistic creations evaluation and improvement services, a plurality of web design services, a plurality of commerce services and the like and plugins enabling said at least one user to utilize functionality on said user web site and provides plugins enabling said at least one user to provide said services on said user web site or provide a link to said user's pages hosted on a third parties' web sites.

11. The system as claimed in claim 1, wherein said gaming module is configured to enable said at least one user to incorporate at least one of a plurality of gaming and a plurality of real life activities in said plurality of multimedia compositions produced on at least one level comprising an individual level and team level as a part of a Role Playing Game (RPG) and a RPG Forum game, and combine at least one media and means for conducting said at least one of said plurality of gaming and said plurality of real life activities over at least one media selected from a group comprising an Internet, a television, a radio, a plurality of publications, and any other media and plugins enabling said at least one user to utilize functionality on said user web site.

12. The system as claimed in claim 1, wherein said plurality of modules further comprises a content control module configured to determine an inappropriate content of at least one advertisement and processing at least one message related to said inappropriate content of said at least one advertisement to an owner of said advertisement.

13. A method for providing education to at least one user in at least one project based and service learning gaming environment comprising the steps of:
creating at least one multimedia composition by said at least one user;
accessing said at least one multimedia composition by said at least one user;
retrieving at least one of an advertisement and a sponsor data from at least one database of a plurality of databases; and
executing a set of instructions to combine said at least one multimedia composition and said at least one of said advertisement and said sponsor data from said at least one database.

14. The method as claimed in claim 13, wherein said method further comprises:
retrieving at least one of a non-profit organization data from said at least one database of said plurality of databases; and
executing a set of instructions to combine said at least one multimedia composition and said at least one of said non-profit organization data and said sponsor data from said at least one database.

15. The method as claimed in claim 13, wherein said method further comprises:
incorporating said at least one multimedia composition in at least one of an e-portfolio, an RPG, a RPG Forum game and the like.

16. The method as claimed in claim 13, wherein said method further comprises:
retrieving said at least one multimedia composition for conducting at least one competition for a best multimedia composition and determining at least one partner and at least one sponsor for said at least one competition.

17. The method as claimed in claim 13, wherein said at least one multimedia composition comprise at least one of a text, image, audio, and video information pieces as a part of said at least one project based learning and a plurality of creative activities.

18. A method for displaying at least one self-multiplying advertisement to at least one user in at least one project based and service learning gaming environment, said method comprising the steps of:
selecting said at least one advertisement from at least one database of a plurality of databases by said at least one user; and
specifying a plurality of parameters for determining a manner of displaying said at least one advertisement by said at least one user; and determining content of a plurality of user pages for inappropriate words, images, and the like associated with said advertisement;
wherein said plurality of parameters comprise a time period, a size, a location, and the like.

19. The method as claimed in claim 18, wherein said method further comprises:
selecting at least one of a particular multimedia composition and any other user creation by said at least one user for combining at least one of a plurality of links each associated with said plurality of databases to a plurality of advertisements and said at least one of an advertisement retrieved from said at least one database of a plurality of databases with said at least one of said particular multimedia composition and said any other user creation;
storing statistics related to at least one click of said advertisement in said at least one database of said plurality of databases;
storing a plurality of URL addresses of a plurality of hosting pages in said at least one database of said plurality of databases; and
determining at least one copy with a highest number of clicks and completed transactions.

20. The method as claimed in claim 18, wherein said method further comprises processing at least one message related to an inappropriate content of said at least one advertisement to an owner of said advertisement and at least one copy with said highest number of clicks and completed transactions are determined by an analytics module.
